(19) United States
(12) Patent Application Publication
(10) Pub. No.: US 2002/0031224 A1
(43) Pub. Date: Mar. 14, 2002

(54) Secure multimedia communications system

(75) Inventors: Ganesh Basawapatna, Greenwood Village, CO (US); Varalakshmi Basawapatna, Greenwood Village, CO (US)

Correspondence Address: BAKER BOTTS, L.L.P., 44TH FLOOR, 30 ROCKEFELLER PLAZA, NEW YORK, NY, 10112-0228, US

(73) Assignee: On Command Corporation

(21) Appl. No.: 09/808,861

(22) Filed: Mar. 15, 2001

Related U.S. Application Data
(63) Continuation-in-part of application No. 09/391,558, filed on Sep. 8, 1999.
(63) Continuation-in-part of application No. 09/149,194, filed on Sep. 8, 1998.
(60) Provisional application No. 60/212,602, filed on Jun. 19, 2000.

(51) Int. Cl. H04N 7/167

(52) U.S. Cl. 380/211; 380/239; 725/59

(57) ABSTRACT

Systems and methods for securely communicating multimedia information from one or more multimedia content sources to a plurality of end users are disclosed. In one preferred arrangement, the system includes a headend system, one or more signal distribution systems, and multiple customer interface devices.

The headend system receives multimedia information signals from one or more content sources and user authorization information corresponding to multiple end users, combines the multimedia information signals into a composite signal, and generates a secure headend output signal. The signal distribution systems include a signal splitter for dividing the secure headend output signal into a plurality of service signals, several signal decoders for converting the service signals into modulated channel signals if authorized by the user authorization information, and several output interfaces for combining the modulated channel signals into a composite user signal. Each customer interface device receives a corresponding composite user signal, and divides and demodulates the signal into end user signals for use by the end user.

### CROSS-REFERENCES TO RELATED APPLICATIONS

This application is a continuation-in-part of Provisional Application Serial No. 60/212,602, filed Jun. 19, 2000 and a continuation-in-part of application Ser. No. 09/391,558, filed Sep. 8, 1999, which is a continuation-in-part of application Serial No. 09/149,194, filed Sep. 8, 1998, each of which are incorporated herein by reference for all purposes.

### BACKGROUND OF THE INVENTION

The present invention relates generally to a multimedia communications system for collecting and distributing selected forms of communication signals, and more particularly to a novel multimedia communications system for collecting and distributing television, telephone, and data signals to and from an end user's site.

Mechanisms are known for coupling multimedia communications signals by fiber optic or coaxial cable directly to a television receiver or through an interface box to the television receiver. These signals, however, are highly susceptible to theft or diversion to other than the subscribing users. A person desiring to steal the signal may tap into the cable line of an intended user or use hardware and/or software which enables reception and interpretation of unauthorized signals or channels.

Known semi-secure communication systems have made use of complex set-top boxes and receiver interfaces. Such systems are costly and often include more features than users require or need, thus increasing the cost of the interface. Furthermore, in many older buildings and systems, the bandwidth for such communications systems is limited, usually to 300 MHz, as are the number of channels in most television receivers.

A typical head end of a multimedia communications distribution system receives analog and/or digitally compressed signals, modulates the signals onto different carrier frequencies, combines the signals, and sends the signals by fiber-optic or coaxial cable to various electronic nodes, each of which typically serves a large number of users, often as many as 300 or more. At the node, the signal may be distributed directly or be converted to those frequencies compatible with equipment at the user sites. Between the head end and the distribution nodes, the path is controlled and secure, and thus the signal is difficult to tamper with.

However, between the nodes and a subscribing user, a number of major problems can occur. The signal may be stolen by the unauthorized tapping into the cable, channels may be descrambled using unauthorized descrambling equipment, and the unintended reception of extraneous signals can cause the quality of signal reception at the user's site to be poor. Finally, with much of the prior art equipment, there is no reverse path which enables a subscribing user to communicate with the signal provider other than through the use of conventional telephone equipment and procedures. This makes the provision of value added services, such as telephone and computer services, dependent upon the telephone company for the return path communications.

Accordingly, there exists a need in the field of multimedia communication for a technique which can both provide for the secure transmission of multimedia information to multiple end users while also enabling user originated signals to be delivered to the multimedia content provider, all without the need to resort to additional hardware and costly third party services.

### SUMMARY OF THE INVENTION

An object of the present invention is to provide a multimedia communications system adapted for providing for the secure transmission of multimedia content to a large number of end users.

Another object of the present invention is to provide a multimedia communications system adapted for permitting a large number of end users to communicate with a multimedia content provider.

A further object of the present invention is to provide a multimedia communications system which is adapted to the inclusion of value added serves without the need for additional hardware or service expenses.

Yet a further object of the present invention is to provide a multimedia communications system which is adapted to utilize existing hardware and wiring to deliver multimedia content.

Still another object of the present invention is to provide techniques for securely transmitting multimedia content which requires a user specific address for decryption.

Still a further object of the present invention is to provide a multimedia communications system which can be used to provide secure multimedia content to multiple dwellings, regardless of size.

In order to meet these and other objects which will become apparent with reference to further disclosure set forth below, the present invention provides systems and methods for securely communicating multimedia information from one or more multimedia content sources to a plurality of end user. In one preferred arrangement, the system includes a headend system, one or more signal distribution systems, and multiple customer interface devices.

In accordance with the invention, the headend system receives multimedia information signals from one or more content sources and user authorization information corresponding to multiple end users, combines the multimedia information signals into a composite signal, and generates a secure headend output signal. In an especially preferred arrangement, the headend system also receives telephony and computer signals, as well as return path signals from the end users.

Each signal distribution system is communicatively coupled to the headend system, and receives a secure headend output signal from the headend system. In one arrangement, the signal distribution system includes a signal splitter for dividing the secure headend output signal into a plurality of service signals, several signal decoders for converting the service signals into modulated channel signals if authorized by the user authorization information, and several output interfaces for combining the modulated channel signals into a composite user signal.

Each customer interface device receives a corresponding composite user signal, and divides and demodulates the signal into end user signals for use by the end user.

In an alternative arrangement useful in loop through wired structures, the signal distribution system includes a signal splitter for dividing the secure headend output signal into a plurality of service signals, several signal decoders for converting the service signals into modulated channel signals if authorized by the user authorization information, and a combining circuit for combining all of the modulated channel signals into a composite multiple user signal.

In this arrangement, a loop through communication channel is coupled to the combiner circuit and receives the composite multiple user signal. Advantageously, each customer interface device i coupled to the loop through communication channel includes a filter permitting transmission of only multimedia information corresponding to the particular customer.

In a further alternative arrangement useful where increased flexibility in system architecture is required, a multimedia communication system including one or more a point of presence systems is described. The point of presence systems may function in a manner similar to a headend system, and are adapted to deliver multimedia information securely to one or more customer interface devices via one or more signal distribution systems. preferably through wireless communication links.

The signal distribution system may include one or more nodes, each having one or more communication lines for connecting to service modules. The service modules preferably include a processor to control and authorize service requests from a customer communication device.

A more complete understanding of the present invention may be derived by referring to the detailed description of preferred embodiments and claims when considered in connection with the figures which are incorporated herein and constitute part of this disclosure, and which illustrate a preferred embodiment of the invention and serve to explain the principles of the invention, wherein like reference numbers refer to similar items throughout the figures.

### BRIEF DESCRIPTION OF THE DRAWINGS

FIG. 1 is a schematic diagram of a multimedia communications system;

FIG. 2 is a schematic diagram of a user or customer interface box forming a part of a multimedia communication system;

FIG. 3 is a schematic diagram of an alternative embodiment of a user or customer interface box forming a part of a multimedia communication system;

FIG. 4 is a schematic diagram of a service module forming a part of a multimedia communication telecommunications system;

FIG. 5 is a schematic diagram of a service module in which the processor communicates with the Integrated Receiver Decoder's with an infrared transceiver;

FIG. 6 is a schematic diagram of a signal distribution system designed for apartment or multiple dwelling unit use;

FIG. 7 is a schematic diagram of a signal distribution system designed for loop-through cable systems;

FIG. 8a is a schematic diagram of a customer interface box which may be used with the signal distribution system of FIG. 7;

FIG. 8b is a schematic diagram of a filter which may be used with customer interface box of FIG. 8a;

FIG. 9 is a flow diagram illustrating a method of using the multimedia communication circuit or system;

FIG. 10 is a flow diagram illustrating a method for customer telephone communication with the multimedia communication system;

FIG. 11 is a flow diagram illustrating a method of customer data or computer communication with a multimedia communication system;

FIG. 12 is a schematic diagram of an embodiment of a multimedia distribution system for delivering multimedia signals to and from a plurality of user sites, which includes use of a local point of presence system;

FIG. 13 is a schematic diagram illustrating a local point of presence system, including a video and data server and transmitter and a service module; and

FIG. 14 is a schematic diagram illustrating two-way communication between a video and data server, a Service Module and the end user.

### DESCRIPTION OF THE SPECIFIC EMBODIMENTS

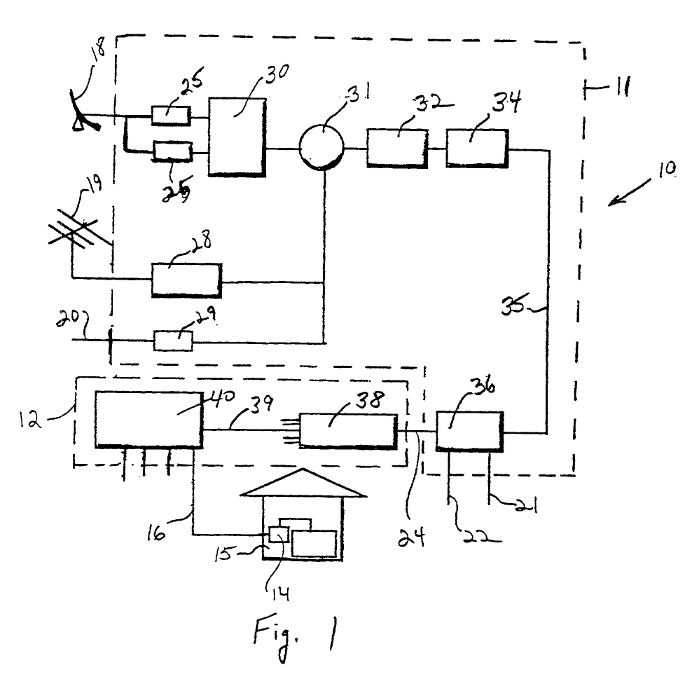

Referring to FIG. 1, an exemplary embodiment of the present invention is disclosed. multimedia communication system 10 is formed by a signal collection and transmission system or circuit 11, (also referred to as a “headend system”), and a signal distribution system or circuit 12, both of which preferably are located at a secured site or sites. A Customer Interface Box 14, located at a user or subscriber site 15, is operatively connected to the signal distribution system 12 by a suitable connection cable 16, such as a coaxial cable, fiber-optic cable, twisted-pair cable, or other suitable wide bandwidth connection means.

In accordance with one embodiment of the present invention, the user site may be a home, office, business, or the like. Such a site typically is not a secure site, so signals received from the multimedia communication system headend may be susceptible to theft or misappropriation. By utilizing the unique signal distribution system embodying the present invention located at a secured site, the signals to and from the user site are limited to those specifically requested by the user, and thus, a substantial improvement in the security of the system is achieved. In addition, as discussed in more detail below, the signal channel from the secured site to the end user site also may be scrambled for additional security.

At signal collection or headend system 11, signals, such as cable, broadcast, pay-per-view, video on demand, and Internet signals, may be received from a variety of sources, such as one or more satellite dish antennas 18, one or more off the air antennas 19, and/or a wide bandwidth cable source 20 carrying a signal from a master headend system (not shown). Additionally, the signal collection or headend circuit 11 desirably includes one or more connections 21 to a telephone network, and one or more connections 22 to a computer system server, such as an Internet connection, or the like.

As one skilled in the art will appreciate, an Internet connection through headend system 11 can be made in a variety of ways. For example, headend system 11 can connect to an Internet service provider (ISP) through a standard phone line, a high-speed DSL line, a coaxial cable, a fiber optic connection or other suitable communication means. However, given the amount of data flowing between headend system 11 and the ISP, the connection 22 between headend system 11 and the ISP is a wide bandwidth connection, such as a coax or fiber optic connection. In accordance with an alternative embodiment, headend system 11 can connect to an ISP through a cable connection, for example, a service provider connected to headend system 11 via wide bandwidth cable source 20, or headend system 11 can include a network server (not shown) for providing Internet connectivity services through cable connections itself.

In accordance with an embodiment of the present invention, signal collection or headend system 11 provides an output signal through a communication connection 24 to signal distribution system or circuit 12. Communication connection 24 may be any suitable high-speed or wide bandwidth connection, but in accordance with one embodiment of the present invention, communication connection 24 comprises a coaxial cable connection or a fiber-optic cable connection. The output signal from signal collection or headend system 11, which is sent through connection 24 to signal distribution system 12, preferably comprises a combination of video and/or television signals for a plurality of channels, as well as telephone, computer data, and system information signals, which signal collection or headend system 11 generates or receives from its various sources. The signal(s) which pass between signal collection or headend system 11 and signal distribution system 12 may be analog, digital, or a combination of both analog and digital, with a digital signal being preferred.

Still referring to FIG. 1, satellite dish antenna 18 may receive analog or a carrier signal that has been modulated with digitally compressed video signals from various satellites. In accordance with one aspect of the present invention, the signals received by satellite antenna 18 preferably are analog. In particular, the analog signals are received from the satellite in a frequency range between about 3.7 and about 4.2 GHz. The analog signal then passes to a low noise block converter (LNB) (not shown) which converts the signal to L-band frequencies (about 950 to about 1450 MHz or higher). Next, the signal passes to one or more Integrated Receiver Decoders 25 which converts each channel residing in the L-band frequency to a baseband frequency. Thus, as one skilled in the art will appreciate, it is preferable to have one Integrated Receiver Decoder for each channel residing in the signal. From Integrated Receiver Decoders 25, the individual baseband channels are modulated to a channel (i.e., carrier frequency) chosen by the cable system operator by modulator video processor 30. In addition, modulator video processor may be configured to encrypt the signals or otherwise scramble the signals so that only the paying subscribers will be able to descramble or decrypt the signals.

Where the signals received by satellite antenna 18 are carrier signals that have been modulated with a digitally compressed signal, the signals may be processed in two different ways, one way for an analog only cable system, and one way for a digital or analog and digital cable system. If the cable system is purely an analog system, or if the cable operator decides to distribute particular digital channels on an analog channel line-up, then the signals are processed in the same manner as discussed above with respect to the analog signals, except that a digital Integrated Receiver Decoder 25 will be used in place of an analog Integrated Receiver Decoder. However, if the cable system has digital capabilities, and the cable system operator wishes to distribute the digital channels in digital form, then an integrated receiver transcoder (“IRT”) may be used to change the digital modulation and the error correction protocol from QPSK modulation to QAM modulation, which is suitable for cable transport. Then, modulator video processor 30 will modulate the digitally modulated RF signal to a desired RF channel position.

Typically, the off-air signals received by antenna 19 are not scrambled. Thus, in accordance with the present invention, the signals preferably pass to a demodulator/modulator unit 28 which demodulates the received signals to baseband and then remodulates the signal channels to the appropriate cable system channel frequency as selected by the cable operator. In addition, as one skilled in the art will appreciate, if the received off-air signal channel already is at the frequency which will be sent to a user, then the demodulator/modulator 28 will not demodulate and remodulate the signal, but will merely pass the signal on.

Finally, signals received via wide bandwidth connection 20, are treated in the same manner as signals received by satellite antennas 18. That is, the signals are decoded and then demodulated and remodulated to a desired channel frequency. If wide bandwidth connection 20 also is providing wide bandwidth Internet connectivity, for example, cable system Internet connectivity using Data-Over-Cable Service Interface Specification or other standards based connectivity, a Cable Modem Transmission System may be used with modulator 29. That is, modulator 29 also could be configured after a Cable Model Transmission System in a Data-Over-Cable Service Interface Specification compliant system or other suitable data transmission system for cable connectivity.

The signals from modulator video processor 30 and the other video modulators/demodulators 28 and 29 then are combined and summed by a combiner circuit 31 into a single video signal. The combiner circuit 31 may be combining analog channels and/or digitally compressed channels that are modulated onto an analog channel. The single video signal preferably comprises all the channels that a customer or user of the system may desire or be capable of receiving. For example, the signal from combiner circuit 31 may comprise local broadcast television channels, cable television channels, pay-per-view channels, and video on demand channels.

A video output signal from combiner circuit 31 then is transmitted to an access control system 32 and data path modulator 34. In accordance with a preferred embodiment of the present invention, access control system 32 keeps track of the user authorization for each channel. For example if a user purchases rights to receive certain cable channels, such as HBO®, Showtime®, pay-per-view channels, or the like, access control system 32 will keep track of the authorization of users to receive these channels. If transmitted as analog signal, the authorization information for each user is typically is sent to the service modules 40 as an out of band signal in a separate frequency range. If transmitted as a digital signal, the authorization information for each user is sent in the form of authorization bits included in the multimedia bitstream. As discussed in more detail below, the authorization information then is used by the service modules to determine whether to send a requested channel to a particular user, or not. As one skilled in the art will appreciate, access control system 32 may comprise a suitable computer database and system for maintaining user authentication information.

Data path modulator 34 preferably is a commercial piece of hardware typically configured to receive user authentication data, as well as other data, such as system messages, and the like, and modulate that data to a particular channel frequency. As one skilled in the art will appreciate, because the communication system of the present invention probably will have a large number of users, a large amount of user authentication data will be transmitted to the service modules 40. Therefore, in one embodiment, it is preferable to send the information through the system on one or more separate channel carrier frequencies, rather than appending the channel authentication information to the individual video channels.

After the data has been modulated to the appropriate frequency, the video and data signal then is sent through a high-speed or wide bandwidth connection 35, such as a fiber-optic or coaxial cable connection, to a signal separator 36. Telephone and computer connections 21 and 22 may likewise be fed to signal separator 36. In accordance with one embodiment of the present invention, signal separator 36 preferably produces a forward path signal which may include video, system data, telephone, and computer signals, and sends the forward path signal to distribution systems or circuits 12 through wide bandwidth communication connections 24. In addition, signal separator 36 preferably extracts telephone and/or computer signals from the reverse or return path signal of communication connection 24 and sends the telephone voice and/or computer data signals over telephone connection 21 and computer connection 22, respectively. Telephone connection 21 may be connected to a local exchange carrier or a long distance carrier, whichever is appropriate. Also, computer connection 22 can be any suitable communication connection, such as standard telephone, high speed telephone (e.g., DSL, ISDN) coax cable, fibre optic, or the like.

As illustrated in FIG. 1, the output signal from headend system 11, the information of which can be in analog form, digital form, or a combination of both, is transmitted through communication connection 24 to signal distribution system 12, which preferably comprises one or more cable nodes 38 and a plurality of service modules 40. Nodes 38 typically are fiber-optic or coaxial cable systems, or combinations thereof, and are constructed to meet the bandwidth requirements of the system. In conventional cable systems, such nodes each typically serve about 50 to 500 customers, and more preferably about 100 customers. In accordance with the present invention, each node 38 typically serves about 10 to about 40 service modules, and each service module in turn serves between about 10 and about 40 user sites.

At node 38 the signal typically is converted from fiber-optic to coaxial form (i.e., optical to RF) using an opto-electronic (O/E) converter circuit and then transmitted to service modules 40. As one skilled in the art will appreciate, as the signals pass to service modules 40, the signals may pass through a number of signal splitters or couplers and amplifiers. Since the signal between nodes 38 and service modules 40 have both forward and return paths, the splitters and amplifiers preferably are configured to handle the dual path.

While the following disclosure will make reference to this exemplary embodiment with separate nodes 38 and service modules 40, those skilled in the art should understand that the particular system arrangement may be modified within the scope of the invention to include architectures where the functionality of both the nodes 38 and modules 40 are combined. Indeed, where the physical distance between a headend and a service module is small, there may be no need to include a node in the system.

In accordance with one embodiment of the present invention, forward path communications (i.e. video and forward path telephone and data) between service modules 40 and Customer Interface Boxes 14 at the user sites 15 preferably occur either at baseband frequency or at a very low frequency channel, such as channels 2, 3, 4 or 5 across connection 16. Also, as one skilled in the art will appreciate, data being transmitted to end users may be transmitted on a separate data channel, which typically will be determined by the cable system and the Cable Model Transmission System. Connection 16 may comprise any suitable connection, such as fibre optic, coaxial cable, twisted pair telephone cable, POTS telephone cable, or any other suitable communications connection. Moreover, more than one communication connection 16 may exist between site 15 and service module 40. The signal from service module 40 to Customer Interface Box 14 preferably is in RF analog form; however, the signal also may be transmitted in digital form. For example, a digital signal may pass through a coaxial connection to Customer Interface Box 14, or an xDSL line may be used to transport the digital information.

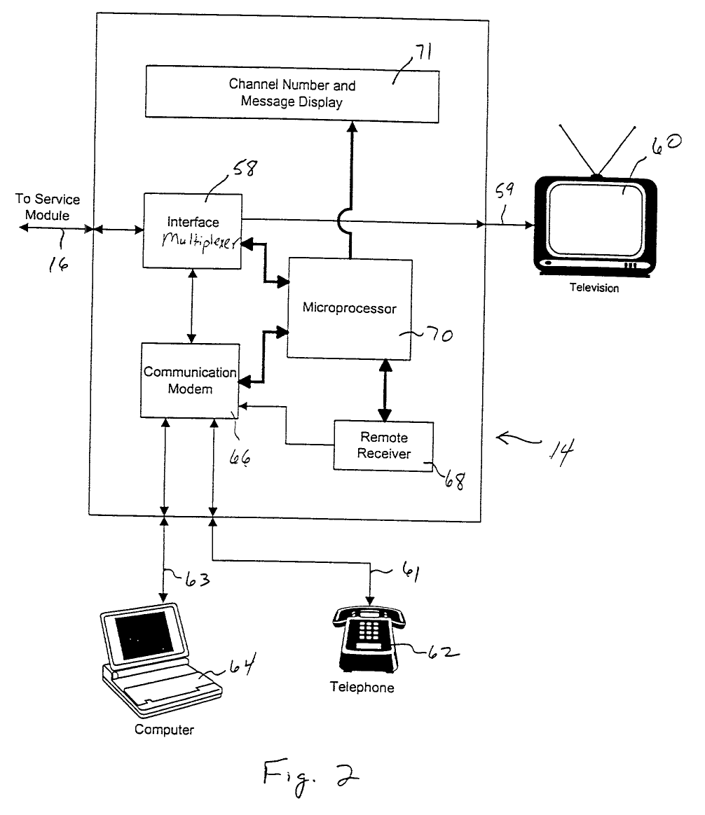

The return path or reverse path communication from Customer Interface Box 14 to service module 40 preferably comprises telephone, computer, and user request data from modem 66 (see FIG. 2) and preferably is modulated onto a carrier frequency between 5 and 50 MHz. In a typical Data-Over-Cable Service Interface Specification compliant system, the Cable Model Transmission System informs the cable modem connected to a computer of the frequency for return transmission. As discussed in greater detail below, Customer Interface Boxes 14 require little built-in intelligence, but can be upgraded to a higher computational level if desired.

Referring now to FIG. 2, a more detailed illustration of one embodiment of a Customer Interface Box 14 is shown. In particular, Customer Interface Box 14 comprises an interface multiplexer (MUX) 58, a modem 66, a receiver 68, a processor 70, and a display device 71. In accordance with one embodiment of the present invention, the signal from service module 40 is received at Customer Interface Box 14 by interface MUX 58 via connection 16. Customer Interface Box 14, and in particular interface MUX 58, is in turn connected by a connection 59 to one or more television sets 60. In addition, interface MUX 58 is connected to one or more telephone sets 62 and one or more computers 64 by connections 61 and 63, respectively.

Interface MUX 58 preferably filters the video signal(s) from the forward path and sends it to the one or more television sets 60 via connection(s) 59. Similarly, interface MUX 58 filters out the forward path telephone, computer data and system message signals and sends them to modem 66. Finally, interface MUX 58 receives return path information from modem 66, which is modulated on a carrier between 5 and 50 MHz and sends the carrier with the return path data back to service module 40. Also, interface MUX 58 may include a decryption or descrambling circuit for decrypting or descrambling the signal from service module 40 if the signal was first encrypted or scrambled prior to transmission to Customer Interface Box 14.

Modem 66 can be any suitable modem, such as a standard telephone line modem, a xDSL compatible modem, a Data-Over-Cable Service Interface Specification compliant cable modem, or any other suitable communication modem

In accordance with the illustrated embodiment, information from telephone set 62, computer 64 and receiver 68 preferably pass through modem 66, which converts the computer data, telephone voice information and user request information to the proper form (i.e., analog or digital), and modulates the information to the return path frequency (e.g., 5-50 MHz). For example, if the signals passed between service module 40 and Customer Interface Box 14 are in analog form, the digital computer signals from computer 64 preferably should be modulated to the proper return path frequency by modem 66 before they are passed over communication connection 16 to service module 40. Similarly, computer signals received by Customer Interface Box 14 should be converted to digital form before being passed to computer 64 or processor 70. Also, as one skilled in the art will appreciate, even if the signals between service module 40 and Customer Interface Box 14 are digital signals, modem 66 may still be needed to modulate the return path information to the proper frequency, and the modem may be need to facilitate the return path communication protocol; for example, if xDSL or another suitable digital communication means is used.

As illustrated in FIG. 2, Customer Interface Box 14 further comprises receiver 68 for receiving user request signals. For example, receiver 68 may be configured to receive user request and message information from a remote control device, such as a laser diode, infrared, or RF remote control device, or receiver 68 may have a cable connection to a signal source (not shown). Thus, Customer Interface Box 14, is addressable by means of a conventional hand-held remote control unit or other similar control device.

The operation of Customer Interface Box 14 in this particular embodiment is controlled by an internal processor 70. For example, in accordance with a preferred embodiment of the present invention, processor 70 facilitates the transfer of the television or video signal from interface MUX 58 to television or display 60. In addition, processor 70 preferably interfaces with modem 66, dictating to the modem how it should handle voice and computer data information. Finally, processor 70 preferably coordinates sending user request and message information received by receiver 68 back to service module 40 (via modem 66), and facilitates the display of channel and system message information on display 71. In this regard, the processor 70 preferably incorporates an LED or LCD display driver. System message information may include billing information, as well as authorization or system messages from the headend or service provider via service module 40.

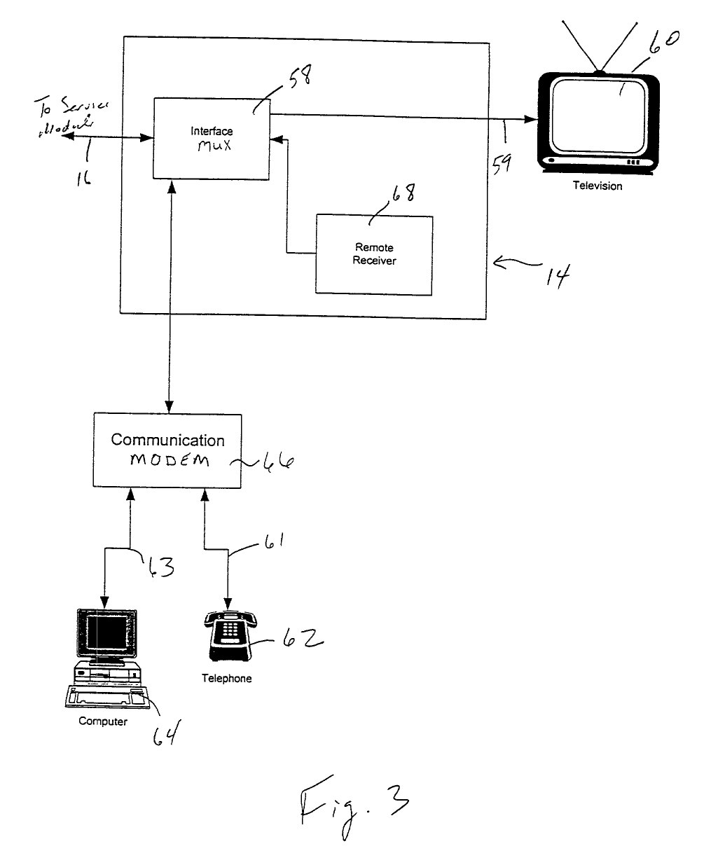

In accordance with an alternative embodiment of the present invention, a cheaper Customer Interface Box 14 having less intelligence could be used. For example, as illustrated in FIG. 3, Customer Interface Box 14 may be configured with an interface MUX 58 and a remote receiver 68 for receiving signals from a remote control device. Interface MUX 58 is configured to receive the voice, data and video signals from service module 40 via connection 16 and split and forward the respective signals to the proper locations. For example, the voice and data signals are passed to communication modem/multiplexer 66, and the video signals are passed to a television set for viewing. As with Customer Interface Box 14 illustrated in FIG. 2 and discussed above, communication modem 66 preferably converts the signal to the appropriate analog or digital form, and then passes the voice signals to telephone 62 and the data signals to computer 64.

As one skilled in the art will appreciate, while FIG. 3 shows the separate video, voice and data signals going to televisions 60, telephone 62 and computer 64 respectively, all the signals may pass to a single display device which can operate as a television, computer and/or a telephone.

In accordance with one embodiment of the present invention, the video and audio portions of the video signal are modulated together onto an RF carrier, for example, channel 2, 3, 4, or the like and transmitted from service module 40 to Customer Interface Box 14 over a communication connection. In one aspect of the invention, the video portion of the signal is in composite video format and the audio portion of the signal is in a single channel audio signal, which could be a two channel stereo signal modulated onto a single channel. In accordance with this aspect of the present invention, Customer Interface Box 14 can pass the composite video and audio signals to the television viewing set or to a home theater or stereo system via a suitable communication connection, such as a coax cable, or other suitable communication cable. Alternatively, Customer Interface Box 14 may be configured with an S-Video (also known as Y/C Video) generator and/or a stereo or surround sound generator. In accordance with this aspect of the present invention, a suitable S-Video or Y/C Video cable and suitable stereo connection cables (not shown) are used to connect the television or home theater system (not shown) to Customer Interface Box 14.

As one skilled in the art will appreciate, an S-Video or Y/C Video generator preferably comprises a suitable comb filter mechanism adapted to separate the Y and C components of the video signal from the composite video signal. The stereo or surround sound generator may comprise any suitable sound mixing system which can create a 2-channel or 6-channel signal from a single audio signal. The surround sound signal may be Dolby AC-3, Sony Dynamic Digital Sound, Digital Theater Systems, or any other.

In accordance with an alternative embodiment of the present invention, instead of Customer Interface Box 14 converting the signal to S-Video and/or stereo audio, service module 40 may do the conversion. This particular embodiment is discussed in more detail below.

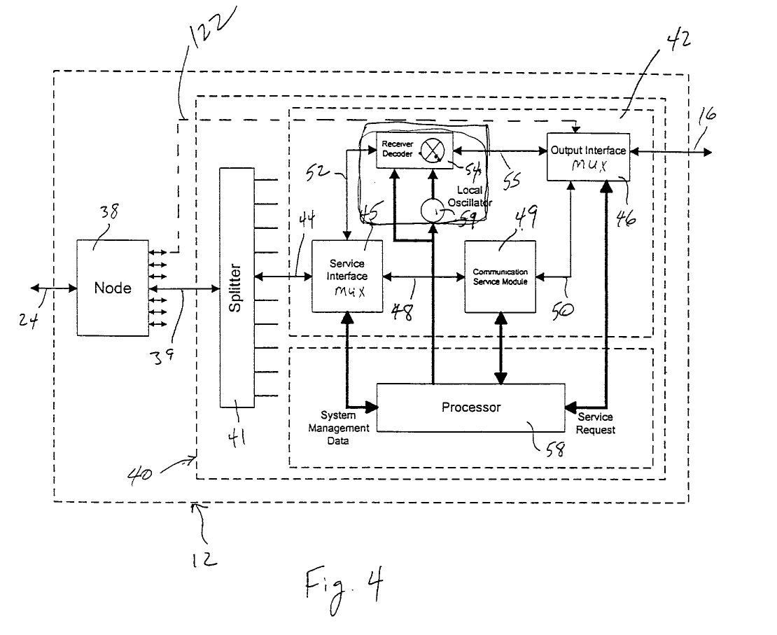

Referring now to FIG. 4, a more detailed illustration of distribution system 12, and in particular service module 40, is shown. As mentioned above, distribution system 12 preferably comprises one or more nodes 38, which connect to a plurality of service modules 40. Such nodes are points at which forward and return signals are split so that they may be provided to multiple Service Modules, e.g., 2, 4 or 10 Service Modules.

In accordance with a preferred embodiment of the present invention, service modules 40 preferably are configured to receive signals from headend system 11 and distribute them to authorized service requesting users at user sites 15 via Customer Interface Box 14. Service modules 40 also can handle two-way telephone and computer traffic for each user. Each service module 40 is designed to serve a number of users simultaneously, such as between about 5 and about 50 users, and more preferably about 20 users.

The present invention is based on the premise that all video communications between service modules 40 and Customer Interface Boxes 14 occur over one or more channels of television bandwidth, typically one channel for each television set having its own Customer Interface Box 14. The channels are communicated either as a baseband audio and video signal, or as a low frequency channel such as 2, 3, 4, or 5. As a result of only one or a few channels being sent to each user site 15, signal stealing is reduced because only a few channels can be stolen at a time, and the party stealing the signal is limited to watching the channel(s) selected by the valid user. In addition, if the valid user turns off his television set, there can be no signal stealing as no signal is being transmitted to the Customer Interface Box. This premise, of course, presupposes that all cable connections and hardware devices between headend system 11 and service modules 40 are secure. Such security can be achieved by providing secure buildings and structures for all headend, node and service module equipment, as well as using sophisticated jamming algorithms and other forms of scrambling and encryption. One skilled in the art will appreciate that the video signal received and processed by service modules 40 may be analog signals, digitally compressed signals, or a combination of both. Therefore, the type of signal (i.e., analog or digital) will dictate the type of scrambling, jamming and/or encryption techniques used. In addition, if additional security is needed, the signal between service module 40 and the user site 15 also can be scrambled, jammed and/or encrypted.

Service module 40 preferably is an addressable or programmable module, which receives an encrypted, scrambled, jammed, and/or frequency shifted signal having a plurality of channels modulated therein from the headed 11 via node 38. Service module 40 then converts a user requested video channel from its modulated frequency in the signal to baseband and then preferably to a low frequency channel and transmits it to the requesting user. Thus, in accordance with a preferred embodiment of the present invention, a significant amount of the intelligence and decision making aspects of the system are provided within service module 40, as shown schematically in FIG. 4. In particular, service module 40 preferably includes a signal power splitter 41 which receives signals from and transmit signals to cable node 38 through a wide bandwidth communication line 39, such as a coaxial cable, fiber-optic cable, or the like. In addition, signal power splitter 41 preferably amplifies and distributes signals to individual user circuits 42 in service module 40, through splitter connections 44.

Individual user segments or circuits 42 of service module 40 preferably communicate with the individual Customer Interface Boxes 14 of each user. Each such user circuit 42 preferably comprises a service interface multiplexer (MUX) 45, an output interface multiplexer (MUX) 46, a communication service module 49, a receiver decoder 54, and a modulator 59. In addition, if the signal from service module 40 to Customer Interface Box 14 is scrambled or encrypted, each user circuit 42 also will include a scrambling or encryption circuit. The scrambling or encryption circuit may be a separate circuit or device within user circuit 42, or the scrambling or encryption circuit may be configured as part of one of the other components, such as receiver decoder 54, modulator 59, output interface MUX 42, processor 58, or the like.

Service interface MUX 45 of service module 40 preferably is configured to receive a communication signal from node 38 via splitter 41 and splitter connection 44. Service interface MUX 45 in turn sends the signal to output interface MUX 46 either through communication service module 49, which handles telephone and computer traffic for the user, or through receiver decoder 54, which handles the video signals.

In accordance with this aspect of the present invention, if the signal includes telephony or computer signals, service interface MUX 45 preferably passes the telephony and/or computer components of the signal to communication service module 49 via connection 48. If the user is authorized to receive the telephony and/or computer signal(s), communication service module 49 then passes the signal to output interface MUX 46 via connection 50. Thus, in essence, communication service module 49 acts as a communication switch allowing the telephony and/or computer signals to pass through if the user is authorized for such services. Otherwise, if the user is not authorized, communication service module 49 will prevent the communication.

As mentioned above, the signal from headend system 11 may be analog, digital signals modulated on to an analog channel, or a combination of both. Regardless of its form, the telephony and/or computer data is modulated onto an analog channel and communication service module 49 preferably passes the digital and/or analog signal to Customer Interface Box 14 if the user is authorized to receive the service.

The video portion of the signal, which may be analog, analog scrambled, or digitally compressed and encoded preferably is passed to receiver decoder 54 via connection 52. Upon receiving the video signal, receiver decoder 54 descrambles or decrypts the signal and converts the particular video channel requested by a user from its modulated or compressed waveform to baseband frequency. Once the signal is at baseband, receiver decoder 54 can pass the signal to output interface MUX 46 via connection 55 at baseband, or receiver decoder 54 can remodulate the signal to a predetermined low frequency channel, such as channel 2, 3, 4 or 5, and send the signal out at that frequency.

As discussed in greater detail below, receiver decoder 54 preferably utilizes modulator 59 to convert the selected channel from its modulated frequency to baseband frequency, and then if appropriate, to the low frequency channel output. Also, if scrambling or encryption is desired, it can be done at this point. The scrambling can be spectral inversion (performed by the local oscillator and/or modulator), synch suppression which makes the signal unwatchable at an unauthorized receiver, or a combination of both techniques. In addition, if the signal from service module 40 to Customer Interface Box 14 is a digital signal, software and/or hardware based digital encryption techniques may be used.

Once output interface MUX 46 has received the analog or digital video, voice and/or computer signals from receiver decoder 54 and communication service module 49, it in turn sends the signal through communication connection 16 to the subscriber or user Customer Interface Box 14. In addition, if the subscriber premise or user site has more than one television that is independently tuned (i.e., has its own Customer Interface Box), service module 40 preferably will have one receiver decoder 54 per television set. Each receiver decoder 54 will modulate each program requested from each television to a different channel, say 2, 3, 4 or 5. The channels then will be combined together by the same output interface MUX 46.

Service interface MUX 45, output interface MUX 46, receiver decoder 54, communication service module 49, and modulator 59 of each user circuit 42 preferably are controlled by a common processor 58. As one skilled in the art will appreciate, processor 58 may comprise any suitable computer processor and may further be configured with memory, storage and communication buses and interfaces, as necessary.

In accordance with one embodiment of the present invention, processor 58 preferably controls all functions for each user of a particular service module 40. For example, processor 58 may be programmed or configured to maintain all billing information, perform routine checks to verify that the signal is not being stolen, handle user requests, control the allocation of system management data and subscriber messages, perform digital encryption processes, and download television and pay channel programming information to Customer Interface Boxes 14. In addition, processor 58 can be configured to receive security information about each household, and perform functions such as meter reading by communicating with meter reading circuitry connected to a data port of Customer Interface Box 14 or connected to a computer which is connected to the Customer Interface Box data port.

Processor 58 preferably provides control signals to the various components of service module 40 to control the operation of the service module and the system. For example, when a user sends a request for a particular video channel, this request preferably arrives at output interface MUX 46 where it is recognized as a service request and sent to module control processor 58. The request message or code preferably includes the channel request, as well as various customer information, such as the customer's identification number, and secret code or password. In addition, processor 58 may be programmed to ask for additional identification information from the user if necessary.

Upon receipt of the channel request and customer information, processor 58 then verifies that the customer or user is a valid customer and also verifies that the customer is authorized to receive the requested channel. If the customer passes the authorization checks, processor 58 sends the appropriate tune signal to modulator 59 and the appropriate descrambling or decoding command to receiver decoder 54.

As one skilled in the art will appreciate, the video or television signal received by service module 40 from headend system 11 may be scrambled or encrypted in accordance with one or more scrambling techniques. For example, encryption, synchronization suppression, spectral inversion, jamming, non-standard frequency modulation, or a combination thereof may be used. In addition, some of the channels modulated in the signal may be analog and others digital. Thus, user circuits 42 preferably are configured to decode or decrypt the signal and handle both analog and digital channels at the same time. For example user circuits 42 may have analog receiver decoders 54 to handle the analog portion of the signal and a digital receiver decoder (or transcoder) to handle the digital portion of the signal. Preferably processor 58 includes the descrambling or decoding intelligence and instructs receiver decoder 54 (and the digital transcoder) as to how to handle the decoding in accordance with the proper decoding scheme. Also, if this signal from service module 40 to Customer Interface Box 14 is to be scrambled, processor 58 will dictate the scrambling technique and control the scrambling process.

For digitally compressed video signals, typically about six (6) to ten (10) channels are compressed together in about 6 MHz of an RF signal. Thus, when digital receiver decoder 54 in user circuit 42 receives the digitally compressed signals it selects the group of digitally compressed signals carrying the requested channel. Receiver decoder 54, preferably using modulator 59, then demodulates the group of channels from its modulated frequency to baseband and decompresses the compressed channels. Then, receiver decoder 54 preferably decrypts the channels if they were encrypted at the headend and selects the one channel that the user requested. Receiver decoder 54 then transmits the clean channel to output interface MUX 46 at baseband, or receiver decoder remodulates the signal to a low frequency channel, such as 2, 3, 4, or 5, as desired, preferably using modulator 59. Output interface MUX 46 then transmits the signal on to Customer Interface Box 14. As one skilled in the art will appreciate, the digital receiver decoder preferably is adapted to handle any digital encryption techniques including asynchronous encryption or synchronous encryption like DES.

For analog video signals, typically one channel is modulated into about a 6 MHz band of an RF signal. Thus, when an analog receiver decoder 54 in user circuit 42 receives the analog signal it converts it from its modulated frequency to baseband, preferably using modulator 59. Then, if baseband scrambling or jamming was used at the headend system, receiver decoder 54 preferably descrambles the channel and transmits the clean channel to output interface MUX 46 at baseband. Alternatively, receiver decoder 54 can remodulate the signal to a low frequency channel, such as 2, 3, 4, or 5, as desired, preferably using modulator 59, and then transmit the low frequency channel to output interface MUX 46. Output interface MUX 46 then transmits the signal on to Customer Interface Box 14. As one skilled in the art will appreciate, the analog receiver decoder preferably is adapted to handle any type of scrambling technique used at the headend system, including RF or baseboard scrambling or jamming. As one skilled in the art will appreciate, if RF scrambling or jamming was used, receiver decoder 54 will descramble the signal prior to converting the channel to baseband or the low frequency channel (2, 3, 4, etc.) Also, instead of converting the desired channel to baseband before converting it to the low frequency channel, modulator 59 can be configured to convert the channel directly from its modulated frequency to the low frequency channel without first converting it to baseband.

During the authorization process, if the customer is an invalid or unauthorized customer, processor 58 preferably sends an alarm to headend system 11 through the system management data bus to inform the headend system that an invalid customer is on the port. Processor 58 also then turns off the modulator 59 for that particular user port 42, in effect disabling the port until the headend system solves the illegitimate request problem. Once the problem is rectified, headend system 11 can reactivate the port, either locally or remotely from the headend system.

In accordance with a further aspect of the present invention, if a customer or user requests a channel which he is not authorized to receive, processor 58 preferably will send a system message to the Customer Interface Box 14 for that user, informing the user that he requested an invalid or unauthorized channel. Preferably, the message will be displayed on display 71 of Customer Interface Box 14 (See FIG. 2) or on the television screen.

In accordance with yet another aspect of the present invention, if the user requests a pay-per-view or video on demand movie or feature, processor 58 checks to see if the user has sufficient credit for that purpose. This can be done in several ways. For example, processor 58 may check a credit report for the user or the user's payment history, which may be held in local memory in processor 58 and periodically updated by the headend 11. If the user has a sufficient credit rating or an adequate payment history, processor 58 will allow the request and bill the user; otherwise, processor 58 will reject the request and send a message to the user stating the reason for rejection. In addition, the system may be set-up so that the user must pre-pay for any pay channel requests. In this manner, the user preferably has an account with payment credits in it. If the user has enough available credits, processor 58 will allow the pay channel request and debit the user's credit account; otherwise, processor 58 will reject the request and send a message to the user stating the reason.

As with the other video channels, if the pay channel request is allowed, processor 58 will direct receiver decoder 54 to select the pay channel from the video signal stream, and modulator 59 will convert the pay channel from its modulated frequency to baseband and then to the appropriate frequency for transmission to the user's Customer Interface Box 14 (e.g., baseband or channels 2, 3, 4, 5, or the like).

In accordance with still a further aspect of the present invention, processor 58 also desirably may include parental control and other filtering capabilities. For example, processor 58 can be programmed to exclude children from receiving certain selected video channels. Thus, for a parent to receive an excluded channel, the parent preferably will enter a secret code which allows the parent to receive the channel.

In accordance with yet another aspect of the present invention, if customer interface box 14 or the user's television set is switched off, processor 58 preferably receives a sign off signal via connection 16 and output interface MUX 46 and shuts off the signal to Customer Interface Box 14. This effectively protects the system from someone tapping into the cable and watching a video channel when the legitimate subscriber is not watching.

When a user or customer attempts to make a phone call, Customer Interface Box 14 preferably formats the return path of the signal with a telephone request message and the phone number to be accessed. Processor 58 then receives the phone request and checks whether the user is authorized to receive the telephone service. If so, processor 58 sends a command to the communication service module 49 to connect the customer's telephone connection to the headend system 11 or directly to a telephone public branch exchange (PBX) or long distance carrier via a suitable communication connection, such as a fiber optic cable, coaxial cable, twisted pair phone line, or a satellite or cellular connection. As mentioned above, if the telephone call is connected to headend system 11, preferably the telephone call is communicated to the headend system via the return path of connection 39 to node 38, and from node 38 via connection 24 to the headend system (see FIG. 1).

In a similar manner, if a user requests data or Internet access services, processor 58 receives the service request and user information from Customer Interface Box 14 via the return path of communication connection 16. Again, processor 58 verifies that the customer is authorized for such services and then, if authorized, instructs communication service module 49 to connect communication device 14, and in particular, computer 64 to the return path back to a computer or internet connection at the headend system, for example, via connection 22 or wide bandwidth connection 20.

In accordance with one embodiment of the present invention, service interface MUX 45 for each user circuit 42 in service module 40 preferably are configured to separate forward and reverse signals to and from headend system 11. Signals from headend system 11 typically comprise various encrypted television broadcast, cable and pay channels which can be in analog form, digitally compressed form, or a combination of both. Signals from headend system 11 also may include forward path data for the customers' computer and/or telephone communications, as well as global and/or individual messages or instructions to the various service modules or individual subscribers. These forward path signals typically are modulated to frequencies above 50 MHz. In a Data-Over-Cable Service Interface Specification compliant system, the forward data channel is a 6 Mhz frequency range that is pre-specified by the system.

Reverse or return path signals from the service modules to the headend system typically comprise telephone and computer communications from the users, as well as customer service requests, pay-per-view program requests and system management data, such as repair, maintenance, and status information messages from the users or the service modules. In accordance with a preferred embodiment of the present invention, return path signals typically are communicated at frequencies below 40 MHz, and more specifically between about 4 MHz and about 40 MHz.

In accordance with this aspect of the invention, service interface MUXs 45 preferably have a 50 MHz high pass filter in the forward path and a 50 MHz low pass filter in the return path, thus separating the forward and return paths of the signals. In addition, service interface MUXs 45 may be configured to create or format the return path signal by combining the outgoing telephone and/or computer communications signals, and the system management data into a block of return path data, and ensuring the return path information or data is formatted or modulated to the appropriate return path frequencies.

However, while in accordance with one described embodiment of the present invention, service interface MUXs 45 are configured to format the return path to headend system 11, one skilled in the art will appreciate that other modules or components of service module 40 may be configured to format the return path data. For example, processor 58 and/or receiver decoder 54 may be used to combine and format the return path data. Thus, the present invention is not limited to the described embodiment.

Output interface MUXs 46 essentially are similar to service interface MUXs 45 and preferably comprise similar low pass and high pass filters. As discussed above, when a customer requests a particular video or television channel, processor 58 directs receiver decoder 54 (and modulator 59) to convert the video channel from its modulated frequency to the signal's baseband frequency, decrypt or descramble the signal, and then transmit the signal at baseband or a low channel frequency, preferably channel 2, 3, 4 or 5. Thus the video portion of the forward path signal from service module 40 to the user site preferably comprises only one channel for each customer interface box 14. In addition, the telephone and computer information portions of the forward path signal to Customer Interface Box 14 may be carried in the vertical blanking interval (VBI) of one or more forward path channels, or the telephone and computer information may be formatted into one or more forward path channels.

In accordance with one embodiment of the present invention, the video portion of the signal transmitted from service module 40 to Customer Interface Box 14 is in composite video form, and the audio portion of the signal is a single audio channel signal, both modulated together in the same RF frequency band. However, in accordance with another embodiment of the present invention, service module 40, and in particular user circuit 42 may be adapted to transmit S-Video (also called Y/C Video) signals and/or 2-channel stereo or 6-channel surround sound signals to Customer Interface Box 14. In accordance with this particular aspect of the present invention, service module 40 may include circuitry to convert the composite video signal into an S-Video (Y/C Video) signal.

For example, a suitable comb filter may be used to extract the Y and C components from the composite video signal. However, since an S-Video signal comprises two separate video signal components instead of a single composite signal, the two signals (Y and C components) should not be modulated to a single modulation frequency. Thus, in accordance with a preferred embodiment of the present invention, each of the Y and C video signal components can be modulated to separate modulation frequency bands and transmitted to Customer Interface Box 14 as separate channels.

In a similar manner, to forward the audio portion of the video signal in stereo mode (2-channels) or surround sound mode (6-channels), service module 40 preferably includes a stereo or surround sound generating circuit which creates the 2 audio channels for stereo or the 6 audio channels for surround sound. As with the S-Video signal, it is preferable to transmit the multiple audio channels to Customer Interface Box 14 at separate modulated frequency bands. In this manner, the stereo or surround sound audio separation is not lost by combining the separate channels into the same modulation band.

In accordance with this particular embodiment of the present invention, Customer Interface Box 14 preferably includes a demodulator for each video and/or audio component of the video signal transmitted in a separate frequency band. For example, if the video signal from service module 40 is transmitted as an S-Video signal and a 2-channel stereo audio signal, the video signal is modulated into 4 separate frequency bands; one for the Y video component, one for the C video component, one for the right stereo audio channel, and one for the left stereo audio channel. In this manner, Customer Interface Box 14 includes at least 4 demodulators for demodulating each component part. After each component part is demodulated to baseband, Customer Interface Box 14 transmits the signal to a television set and/or a home theater system using suitable connections. For example, the S-Video signal preferably is transmitted to the television set using an S-Video cable, and the stereo channels are transmitted to the television set or stereo system using suitable audio connections, such as cables with RCA connectors or the like.

In accordance with another embodiment of the present invention, if a user site has more than one television, that user site may have more than one Customer Interface Box 14; one for each television set. Since the user site typically will only have one communication connection to a service module 40, in order for each television set to display a different video signal than the other television sets at the user site, multiple video channels should be transmitted to the user site. Preferably one channel for each television set and associated Customer Interface Box 14 is transmitted to the user site via communication connection 16. Thus, to accommodate such a configuration, each such Customer Interface Box 14 associated with each television set must be tuned to a different channel, for example 2, 3, 4, 5, etc., and the forward path signal to the user site will include a multiple channel signal, one channel for each device. Moreover, each Customer Interface Box can be configured to limit the channel that its user can tune to.

If the signals from service module 40 are in S-Video and/or stereo audio form, each television set in the home preferably will receive a plurality of frequency bands, one for each component of the video signal for that television set.

In accordance with yet another embodiment of the present invention, instead of each television set in the home having a separate Customer Interface Box 14, a single Customer Interface Box 14 may be configured to receive multiple signals; preferably, one signal for each television set in the home. In accordance with this particular embodiment, since interface MUX 58 in Customer Interface Box 14 typically is configured to receive all requested channels for each television set in the home from service module 40, there is no need for additional Customer Interface Box's other than to process separate channel requests for the separate television sets. In this manner, it is possible for Customer Interface Box 14 to be configured to receive RF or other transmissions from multiple remote control devices, allowing remote control devices associated with each individual television to control the channel input for the television the remote is associated with, without the need for additional Customer Interface Boxes in the home.

As mentioned above, Customer Interface Box 14 preferably communicates service request information, and computer and telephony information, if appropriate, to service module 40 via the return path of connection 16. For example, the typical return path of a standard coaxial cable communication connection is the frequency range between about 4 MHz and about 40 MHz. However, in accordance with an alternative embodiment of the invention, the return path can be configured at higher frequency ranges, such as one of the channel frequency ranges between about 50 MHz and about 500 MHz. If communication connection 16 between service module 40 and Customer Interface Box 14 comprises an xDSL connection, the video and audio signals may be sent from service module 40 to Customer Interface Box 14 at baseband. In accordance with this particular embodiment of the invention, the return path from Customer Interface Box 14 to service module 40 then is between about DC and about 128 KHz.

In accordance with another embodiment of the present invention, instead of Customer Interface Box 14 communicating with service module 40 via the return path of communication connection 16, Customer Interface Box 14 may communicate with service module 40 via a separate communication connection. For example, service requests, data, and telephony signals from Customer Interface Box 14 to service module 40 may occur over a standard telephone line, or via another communication connection like PCS, cellular, local multi-point distribution system (LMDS), or the like. Also, service module 40 may communicate with headend system 11 in a similar manner. Therefore the present invention is not limited to using the return path of standard coaxial cable or fiber optic connections.

As discussed above, the return path from Customer Interface Box 14 to service module 40 preferably is configured to carry data from a user's computer, outgoing telephony signals and user service requests. However, in accordance with yet another embodiment of the present invention, in the event a customer's computer is configured to receive information at baseband, a separate connection from service module 40 to the user site can be provided for carrying the separate baseband output from service module 40 to the computer. Such connection may be a separate cable fibre or copper wire connection so as not to interfere with other data and television signals between the user site and the service module. The computer could connect directly to this connection via a modem, or the like without connecting to the Customer Interface Box.

The main function of communication service module 49 as shown in FIG. 4 is to handle all voice and data communication according to the needs of the user. As mentioned above, the user's Customer Interface Box 14 either includes or has connected to it a modem so that data is presented to service module 40 properly formatted. Thus, if processor 58 authorizes a telephone and/or computer service request, communication service module 49 acts as a switch, allowing the telephone and/or computer communication to transfer to service interface MUX 45, and ultimately to the headend system.

As mentioned above, computer and telephony information may be carried in the forward path from service module 40 to Customer Interface Box 14 in a high frequency dedicated channel (i.e. >50 MHz), in the 4-40 MHz band, or the information can be encoded in the vertical blanking interval (VBI) of one or more video channels.

In accordance one embodiment of the present invention, the forward path data is transmitted from the headend to service module 49 and then on to Customer Interface Box 14 using a data-over-cable service interface specification (Data-Over-Cable Service Interface Specification) system or other suitable data-over-cable system. In accordance with this aspect of the present invention, the headend has a Cable Model Transmission System, which includes a modulator and demodulator for modulating the forward path data (i.e., from the headend to the end user Customer Interface Box via a service module) to a particular frequency and for demodulating the return path data (i.e., from a user's computer via a Customer Interface Box a service module). The Cable Model Transmission System also provides an interface between the cable system and the Internet backbone, either locally, or by reaching a remote Internet backbone point of presence via a wide area network. The Cable Model Transmission System typically will modulate the data to a frequency above 50 MHz and then tell the cable modem which frequency to use for the return path (typically between 4 and 40 MHz).

When the data reaches service module 40, communication service module 49 will pass the data signal to each Customer Interface Box 14 connected to service module 40. The Data-Over-Cable Service Interface Specification compliant cable modem in Customer Interface Box 14 or connected to Customer Interface Box 14 then will extract the portion of the data signal intended for that particular user. As one skilled in the art will appreciate, each Customer Interface Box and cable modem connected to service module 40 will receive the entire data signal (i.e., data for all users connected to the service module), not just that particular end user's data. In accordance with this aspect of the present invention, the cable modem is configured to extract the data for its particular end user from the composite data signal.

For the return path, the cable modem will modulate the return data to a frequency determined by the Cable Model Transmission System (typically below 40 MHz). The return path data will pass from Customer Interface Box 14 to service module 40. At service module 40, communication service module 40 will pass the return path data to the Cable Model Transmission System at the headend.

Cable telephony will be handled in a similar manner. Communication service module 49 in service module 40 will pass the telephony communication between the headend and each Customer Interface Box 14. In accordance with this aspect of the invention, Customer Interface Box 14 may be equipped with a cable telephone network interface device (NID) for handling the cable telephone functionality.

In accordance with another embodiment of the present invention, data and telephony communication between service module 40 and the user modem 66 of Customer Interface Box 14 may be on a separate dedicated two-way communication line, such as a telephone line or the like. In this case, communication module 49 will handle both forward and return data in the same manner as discussed above. Similarly, the system can be configured so that forward path communication between service module 40 and Customer Interface Box 14 is via communication line 16, and the return path communication from Customer Interface Box 14 to service module 40 is via a separate communication line, such as a twisted pair telephone line (POTS, xDSL, etc.), or the like.

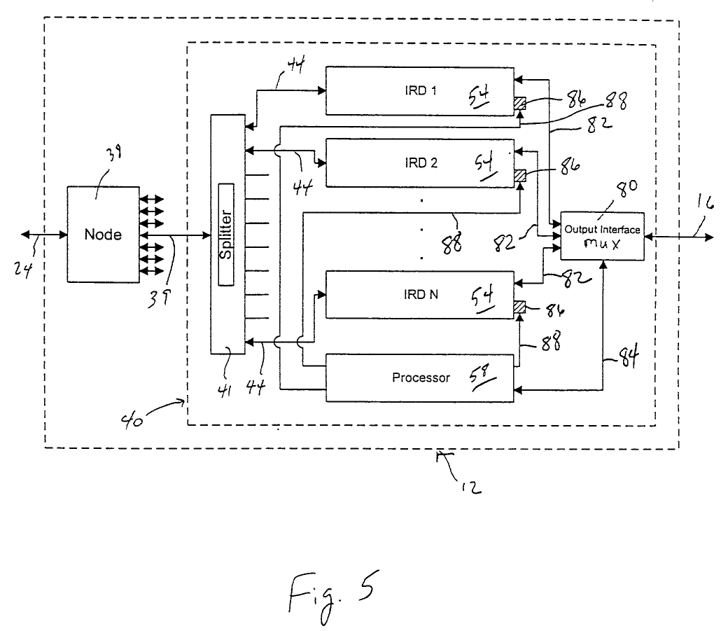

Referring now to FIG. 5, another embodiment of a service module 40 is illustrated. In accordance with this particular embodiment of the present invention, service module 40 preferably is configured to only provide video services to the end user. In this manner, service module 40 includes an Integrated Receiver Decoder 54 for each end user television connected to service module 40. Service module 40 of this particular embodiment may be configured from a plurality of commercially available Integrated Receiver Decoders. However, many commercially available Integrated Receiver Decoder's receive commands from infrared remote control devices. Therefore, in order for processor 58 to communicate with Integrated Receiver Decoder's 54, infrared transmitters 86 preferably are used. Processor 58 sends commands to infrared transmitters 86 via communication connection 88, and transmitters 86 communicates the commands to Integrated Receiver Decoder's 54 using an infrared transmission. When Integrated Receiver Decoder 54 receives the command from processor 58 to select and transmit a particular video channel, it 54 selects the requested channel, decrypts or descrambles it, converts it to baseband or a low frequency channel, and then sends the channel to output interface MUX 80 for transmission to the associated Customer Interface Box 14. Service module 40 may comprise a single output interface MUX 80 for all Integrated Receiver Decoder's 54 as illustrated in FIG. 5, or each Integrated Receiver Decoder 54 may have its own output interface MUX 80 associated with it. This allows the use of commercially available Integrated Receiver Decoders to accomplish the same goal of using existing wiring.

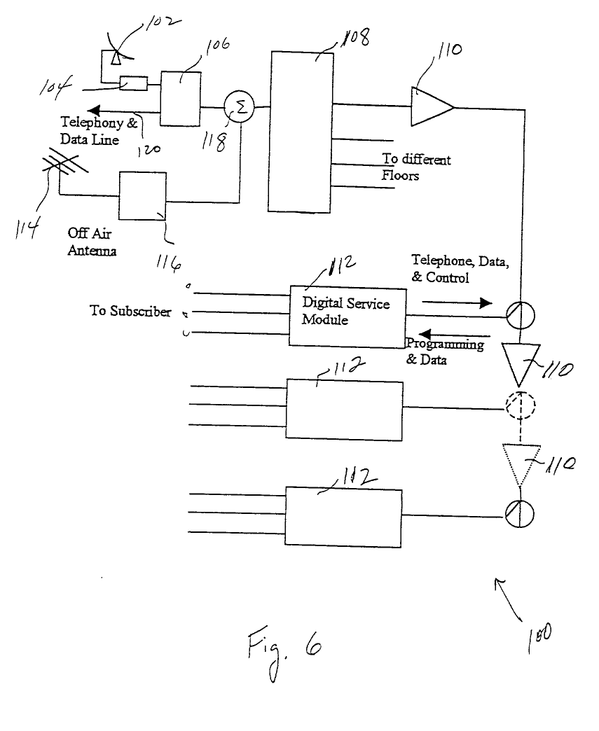

Referring now to FIG. 6, another embodiment of the present invention is shown. In accordance with this particular embodiment, a multimedia communications system 100 is configured to deliver a variety of services to customers or users residing in Multiple Dwelling Units or Shared-Antenna Complexes, such as apartment houses, town homes, a cluster or group of single family homes, office buildings, campuses, or any other group of users that utilize a single antenna or common group of antennas.

As one skilled in the art will appreciate, delivering direct-to-home satellite transmission to residents in Multiple Dwelling Unit complexes or Shared Antenna Complexes is difficult because it is difficult or impossible to add individual satellite antennas for each unit. Thus, to overcome this problem, some Shared Antenna Complexes place a single antenna or group of antennas on the roof or other location on the Shared Antenna Complexes property and transmit the signal to the individual resident homes. The antennas typically are 18″ Ku band antennas, 30″ medium power antennas, or the larger C-band television receive only (TVRO) antennas.

The problem with these systems is that they require separate, expensive receiver decoders for each resident unit, increasing the cost of the system, and thus making it difficult to compete with traditional cable television systems. In addition, the current systems have no means for providing additional telephone and computer access services. Therefore, it is desirable to have a system which can provide satellite television, local television, telephone and computer services to customers in Shared Antenna Complexes at a reasonable expense.

The multimedia communications system 100, illustrated in FIG. 6 is configured to provide such services. In particular, multimedia communications system 100 comprises one or more master antennas 102, a low noise block (LNB) converter 104, a multiplexer (MUX) 106, a power divider circuit 108, a plurality of signal amplifiers 110, and one or more service modules 112.

In accordance with one embodiment of the present invention, master antenna 102 is configured to receive a variety of encrypted television programming channels from a direct broadcast satellite (DBS) video service provider. The video channels may comprise a variety of cable channels, as well as pay-per-view and video on demand services. Preferably, the video signal received by antenna 102 is a 500 MHz bandwidth or a 1000 MHz bandwidth signal in the Ku frequency band. LNB converter 104 receives the signal and converts it to the L band frequency range, approximately 950 to 1450 MHz and 1450 to 2050 MHz. This 500-1000 MHz bandwidth signal may be divided into about 20 to about 40 transponder slots, each of which may carry an analog video channel or about 1-20 digitally compressed video channels. Each transponder slot comprises a frequency band of between about 25 MHz to about 50 MHz, and more preferably about 36 MHz.

From LNB converter 104, the analog and/or digitally compressed video signal passes to MUX 106, which as discussed in greater detail above, separates the downstream signals from the return path signals. From MUX 106, the signal passes through power divider circuit 108, which divides and amplifies the signal into a plurality of signals, preferably one signal for each floor or two, townhouse group, or groups of apartments, such as cluster homes, garden apartments, etc. The output from each individual divided line then is transmitted to one or more service modules 112 for the particular floor or group. As one skilled in the art will appreciate, as the signals are transmitted to the various service modules 112 on the various floors or home groups, it may be desirable to amplify the signals as they are transmitted. Thus, as illustrated in FIG. 6, the signals may pass through one or more signal amplifiers 110. The number and location of signal amplifiers 110 will depend on the particular configuration of the Shared Antenna Complexes.

In accordance with another embodiment of the present invention, the signal from antenna 102 and LNB 104 may be converted to an optical signal using an electrical to optical converter (not shown) and sent over a fiber-optic cable to the service modules 112 on the various floors or at other relatively secure locations. The service modules 112 then preferably are configured to convert the optical signal back to electrical and then process the signal accordingly.

In accordance with the illustrated embodiment, service modules 112 are similar to the service modules discussed above with reference to FIG. 4. Therefore, service modules 112 may be configured to receive the video signals in analog form, digitally compressed form, or both. If handling digitally compressed signals, which signals from the satellite typically are, service modules 112 includes circuitry to decompress digitally compressed video signals. In accordance with this aspect of the invention, service modules 112 preferably comprise about 10 to about 20 integrated receiver decoders or Integrated Receiver Decoder chipsets (interchangeably referred to herein as Integrated Receiver Decoders) (one for each user television connected to service module 112).

The Integrated Receiver Decoders, which are commercially available chipsets that include a receiver/decoder 54 and an oscillator 59 (shown in FIG. 4) preferably extract the transponder frequency band from the compressed video signal that includes the requested channel for the particular user and demodulates it to baseband frequency. The Integrated Receiver Decoder then decompress the frequency band into the 10 to 20 individual channels that were digitally compressed into that band. If the signal was sent encrypted, the Integrated Receiver Decoder or the processor then decrypts the signal. Finally, service module 112 extracts the requested video channel and transmits it to the user at baseband, or remodulates the signal to a channel frequency, such as channel 2, 3, 4 or 5. If service module 112 receives analog video signals, it preferably will process these signals in the same manner as service modules 40 in FIG. 4.

In accordance with another embodiment of the present invention, system 100 further may comprise an antenna 114 for receiving local broadcast television signals, and/or a cable connection (not shown) for receiving channels from a cable company. As one skilled in the art will appreciate, local broadcast channels typically are analog, unencrypted and are resident in the 50-850 MHz bandwidth. In accordance with this aspect of the present invention, the signal from antenna 114 preferably passes to a frequency converter 116, which may or may not convert the received local broadcast signals to different frequencies. From frequency converter 116, the signal passes to a summing circuit 118. Similarly, channels from the cable system may be passed directly to summing circuit 118, or they first may be converted to different frequencies prior to being passed to summing circuit 118.

Summing circuit 118 may combine the local broadcast signals and the cable signals with signals received from satellite antenna 102 and passes the signals to power divider 108. In this manner, system 100 can provide satellite channels, local broadcast channels and channels from a cable company to the users, a solution which most satellite service providers cannot currently provide, even to stand alone homes. Also, as one skilled in the art will appreciate, if the local broadcast and cable signals are analog and the satellite signals are digital signals modulated to some analog channel frequencies, the summing circuit 118 will sum the signals and pass the summed signals to service module 112. Service module 112 then will be configured to process both analog and digital signals. In addition, in accordance with an alternative embodiment of the present invention, instead of combining the analog and digital signals, the analog signals may be passed to service module 112 on one communication connection and the digital signals may be passed to service module 112 on a separate communication connection.

In accordance with one embodiment of the present invention, the local broadcast channels are received by service module 140 and passed to an end user without being processed by service module 112. For example, the local broadcast signals pass from node 38 directly to output interface MUX 46 via a communication path 122 (see FIG. 4) and then out to the end user via communication connection 16. In this manner, end users can receive local broadcast stations via connection 16 without having a Customer Interface Box 14 and without subscribing to cable or DBS services.

System 100 also can be configured to provide telephone and computer services to the customers residing in the Multiple Dwelling Units and/or Shared Antenna Complexes. As with the system illustrated in FIG. 1 and described above, customer service requests, as well as telephone and computer access preferably originate from a Customer Interface Box located at the user site. From the Customer Interface Box, the service requests and telephone and computer signals are communicated to service modules 112. Service modules 112 process the service requests and forward the telephone and computer signals on to a telephone system and/or a computer or internet access facility, respectively. In accordance with this aspect of the invention, the telephone and computer signals from service modules 112 preferably pass back through MUX 106, which separates the forward and return path signals. The return path signals (i.e., telephone and computer signals) then are connected from MUX 106 to the appropriate locations via a suitable connection 120, such as a phone line, cable line, cellular connection, microwave transmission or the like. For example, a telephone call may be connected to a local PBX, or the telephone call may be connected directly to a long distance carrier. Similarly, the computer signals may be connected to one or more Internet or computer network access services, as discussed above.

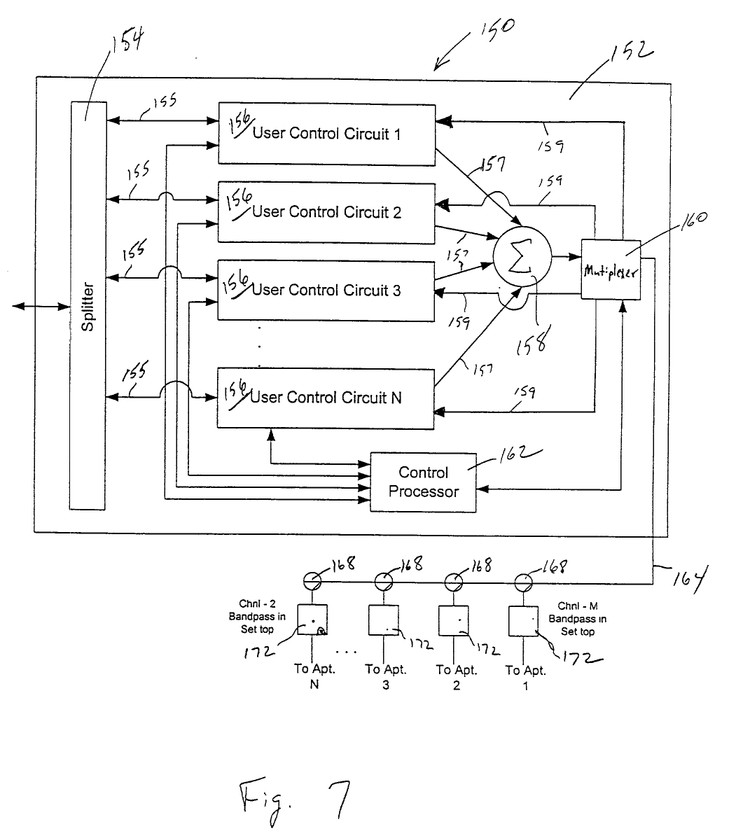

Referring now to FIG. 7, yet another embodiment of the present invention is shown. In accordance with this particular embodiment of the present invention, a service module 152 is configured to provide multimedia communication services to users wired together serially in a loop-through system. For example, in many older apartment buildings, a single cable passes serially from one apartment to the next, and so on. Typically, a loop circuit will connect apartments on the same floor, although it does not have to be configured that way. In accordance with these loop-through systems, each apartment typically comprises a coupler that splits off the signal so that one or more televisions in that apartment can be connected to the loop-through system. Buildings with loop-through wiring traditionally have been very difficult to upgrade to provide premium channels, pay-per-view channels, or even additional cable channels. In addition, it is extremely difficult to provide two-way communications, such as telephone and computer services over the cable with the traditional loop-through systems. However, service module 152 is adapted to provide such services to users connected to loop through systems.

In accordance with this particular embodiment of the present invention, service module 152 preferably comprises a splitter 154, a plurality of User Control Circuits 156, a summing circuit 158, a multiplexer (MUX) 160, and a control processor 162. As with service module 40 illustrated in FIG. 4, splitter 154 is configured to receive signals from and transmit signals to a headend system providing video, telephone, and/or computer services. In addition, splitter 154 amplifies and distributes signals to individual User Control Circuits 156 in service module 152 through splitter connections 155.

As with the user control circuits 42 of service module 40, user control circuits 156 are configured to communicate with the individual apartments in the loop-through circuit, and comprise a service interface MUX, an integrated receiver decoder, a communication service module, and a modulator. The service interface MUX, the integrated receiver decoder, the communication service module, and the modulator all operate in the same manner as the equivalent components in service module 40 discussed above, except that instead of each Integrated Receiver Decoder in User Control Circuit 156 transmitting video channels at base band or at a low frequency channel like 2, 3, 4, or 5, in the loop-through system, the video signal to be sent to the apartment furthest away from service module 152 preferably is modulated onto channel 2, the signal for the next closest apartment preferably is modulated onto channel 3, and so on, with the signal for the nearest apartment to service module 152 being modulated onto the highest channel number.

With this particular configuration, if there are “N” number of total apartments on the loop through circuit, at least “N” User Control Circuits 156 are provided in Service Module 152, and the Integrated Receiver Decoder in User Control Circuit “N” preferably modulates its requested video signal to the frequency associated with channel M, where M=N+1. Thus, for example, if a loop-through system on a particular apartment building floor services ten (10) apartments, the video signal for the apartment closest to the service module, preferably will be modulated onto channel 11. This particular configuration minimizes the loss to the furthest apartment.

In an alternative arrangement, less than N User Control Cards 156 are included in Service module 152. Such an arrangement is more economical in that less hardware is required to provide multimedia communications services to the same number of users, and is a preferable arrangement in situations where it is known that all users will not be using the system at the same time. In places such as hotels and apartments, usually no more than 30-40% of residents are using a pay service at any given point in time. The use of a smaller number of Service Modules, for example, at 30% utilization, cuts the hardware costs per apartment or hotel room to 30% of what would otherwise be required, which can be a significant savings.

After the Integrated Receiver Decoders in User Control Circuits 156 modulate the signals to the particular channel frequencies, the modulated output from User Control Circuits 156 then are passed to a combiner circuit 158 via connections 157, and combined into a single signal. The signal then is transmitted through an output MUX 160 to cable 164 feeding all the apartments in the loop-through circuit. The loop-through cable 164 passes through a coupler 168 at each apartment, thus tying each apartment to the loop-through circuit. That is, at least one Customer Interface Box 172 in each apartment are attached to the loop-through circuit through a coupler 168.

To extract the proper channel for each apartment, coupler 168 for Customer Interface Box 172 preferably includes a band pass filter which allows only that particular apartment's channel(s) to be made available to the television set(s) in that apartment. For example, for apartment 1, coupler 168 or Customer Interface Box 172 includes a band pass filter which allows only channel 2 to be viewed by the users in apartment 1 an no other channels. Similarly, in apartment “N”, coupler 168 or Customer Interface Box 172 includes a band pass filter (not shown) which allows channel “M” to be viewed by the users in apartment “N”. In this manner, service module 152 can provide the premium and pay-per-view channels to users who pay for those services.

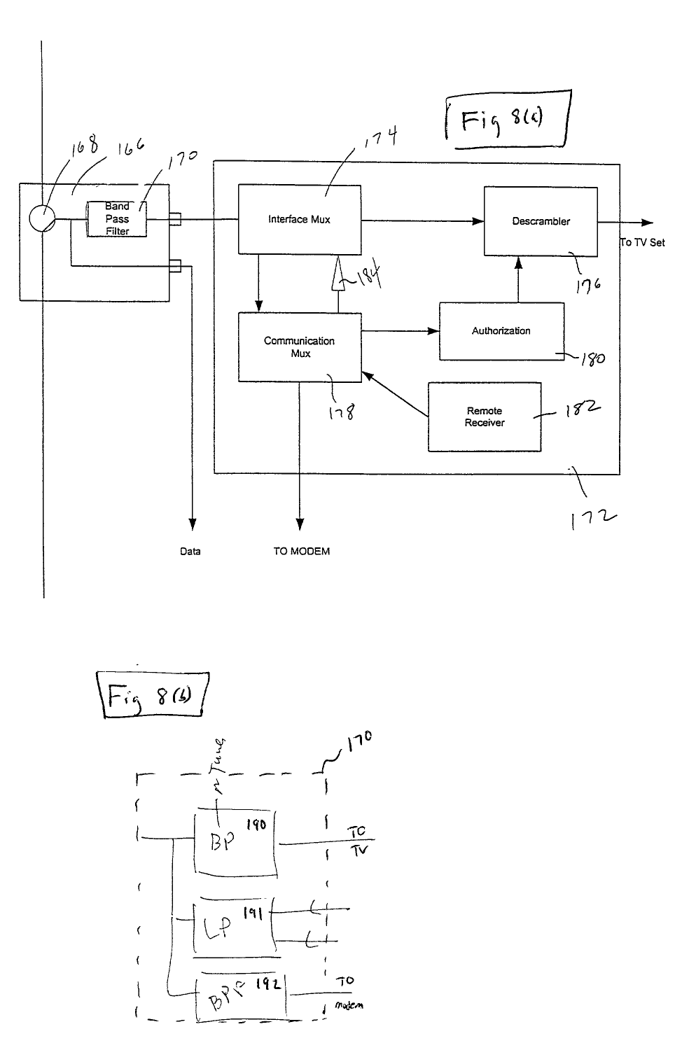

As one skilled in the art will appreciate, if the band pass filter is configured with coupler 168, only a single channel will pass to Customer Interface Box 172. However, if the band pass filter is configured in Customer Interface Box 172, all channels 2-M will pass to Customer Interface Box 172 in each apartment, and the proper channel for a particular apartment will be extracted by Customer Interface Box 172. In accordance with a preferred embodiment of the present invention, to prevent users in apartments from stealing signals directed to the other apartments, coupler 168 and the band pass filter preferably are configured together, and apart from Customer Interface Box 172 (see FIG. 8).

Referring now to FIG. 8, a more detailed diagram of a coupler box 166 and a Customer Interface Box 172 are illustrated. In particular, coupler box 166 includes a splitter or coupler 168 and a band pass filter 170. Customer Interface Box 172 includes an interface multiplexer 174, a descrambler 176, a communication multiplexer 178, an authorization module 180, and a remote receiver 182.

In the embodiment illustrated in FIG. 8, the splitter or coupler 168 and band pass filter 170 are configured separate from Customer Interface Box 172. However, in accordance with an alternative embodiment of the present invention, splitter or coupler 168 and band pass filter 170 may be configured within Customer Interface Box 172.

The band pass filter 170 is described in greater detail with reference to FIG. 8(b). The filter preferably includes three filters, band pass filter 190 for filtering video signals, low pass filter 191 for filtering voice and return path communications, and a band pass filter 192 for filtering communication signals provided to and received from a computer connected to a DOCSIS or other cable modem (not shown). Alternatively, the band pass filter 190 may be replaced by a Service Module controlled tuner. Such a tuner cannot be changed by user, and is set to tune only the frequency(s) selected by the Service Module.

Each coupler 168 and band pass filter 170 combination only allows the channel(s) associated with a particular apartment to pass to Customer Interface Box 172. The signal passes from coupler 168 to band pass filter 170 and then to interface multiplexer 174, which separates the video channels, reverse path data and the forward path data, voice information and computer signals. The video channels pass from interface multiplexer 174 to descrambler 176. If one or more television sets in that apartment are authorized to receive premium or pay channels, the descrambler will descramble the premium or pay channels and make them available to the television sets in the apartment. As one skilled in the art will appreciate, if an apartment has more than one television set, the apartment may receive multiple video channels; preferably one for each television set.

The forward path data, voice and authorization information are divided out by interface multiplexer 174 and passed to communication multiplexer 178. The data information, voice information and authorization command information are sent to the individual customers on dedicated channels determined by the cable system and/or assigned in the service module. These frequencies are common to all subscribers, with the data, voice and authorization command information having additional address information, so that Customer Interface Box 172 will receive and process the data, voice and authorization information directed to that Customer Interface Box for only that apartment.

When communication multiplexer 178 receives the data, voice and authorization command information, it separates the information and passes the data and voice information to a modem, and passes the authorization information to authorization module 180. The modem will process the voice and data information in a manner similar to the modems illustrated in FIGS. 2 and 3 and described above. Authorization module 180 receives the authorization information, processes it, and sends descrambling commands to descrambler 176. That is, if the user in the particular apartment is authorized to view a premium channel or a pay-per-view channel, authorization module 180 will verify the authorization information and then pass a descrambling command to descrambler 176. Upon receipt of the descrambling command, descrambler 176 to descramble the scrambled signal. As discussed briefly above, descrambler 176 may comprise a diode circuit that, upon command, restores the synchronization pulse, allowing the picture to be horizontally synchronized. In addition, descrambler 176 may encompass other descrambling or decryption techniques.

As discussed above, a user of Customer Interface Box 172 in an apartment can select the channel he/she wants to watch by using a remote control device. Remote receiver 182 will receive the signal from the remote control device and pass it to communication multiplexer 178. In addition, voice and/or computer data from a modem or directly from a telephone or a personal computer also will pass into communication multiplexer 178. Communication multiplexer 178 will format this information into the 1 to 40 MHz bandwidth spectrum. Communication multiplexer 178 then will pass the reverse path information through a reverse path amplifier 184 into interface multiplexer 174. Reverse path amplifier 184 amplifies the signal so that the losses caused by the splitter in the return transmission path are compensated for. Interface multiplexer 174 then will pass the information back through coupler 168 and then back to service module 152. As one skilled in the art will appreciate, while amplifier 184 is positioned between communication MUX 178 and interface MUX 174, the amplifier can be located anywhere in the circuit, including within communication MUX 178 and/or interface MUX 174.

At service module 152, the return path data is handled in a manner similar to service module 40 is discussed above. That is, the return path data, including service requests and telephone and computer information, preferably transmit back to MUX 160 through the return path of loop-through cable 164. MUX 160 passes service requests to control processor 162 and the computer and voice information for each apartment back to the User Control Circuit 156 associated with that apartment via connections 159. For the service requests, control processor 162 verifies that the customer is authorized to receive the requested channel. If so, control processor 162 sends a message to the Integrated Receiver Decoder associated with that user to demodulate and descramble that channel and provide it to the requesting user. The protocol does not change even though the Customer Interface Boxes are on a serial bus rather than on a parallel bus, since each Customer Interface Box 172 must identify itself to the microprocessor. However, when more than one user makes a request, a queuing system preferably is used. In this manner, control processor 162 preferably handles the service requests on a first come, first served basis.

While not discussed in detail herein, service module 152 and, in particular, User Control Circuits 156 will handle the telephone and computer services in a manner similar to service modules 40 as discussed above. Also, while this embodiment of the present invention is described herein with reference to apartments with loop-through configurations, one skilled in the art will appreciate that the present invention can be used with other loop-through set-ups. For example, rural cable systems in which individual farm houses are connected to a single cable with couplers or splitters also can utilize the present invention. As used herein, the term loop-through is meant to encompass all such systems wherein a single cable or other communication channel is used to deliver multimedia information to multiple users.

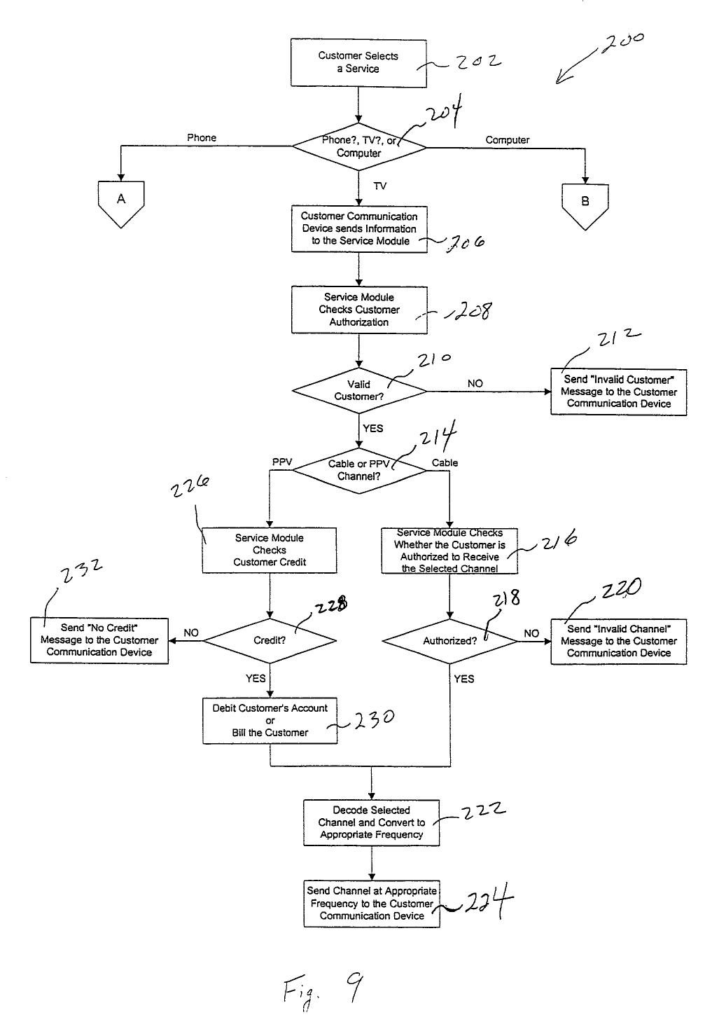

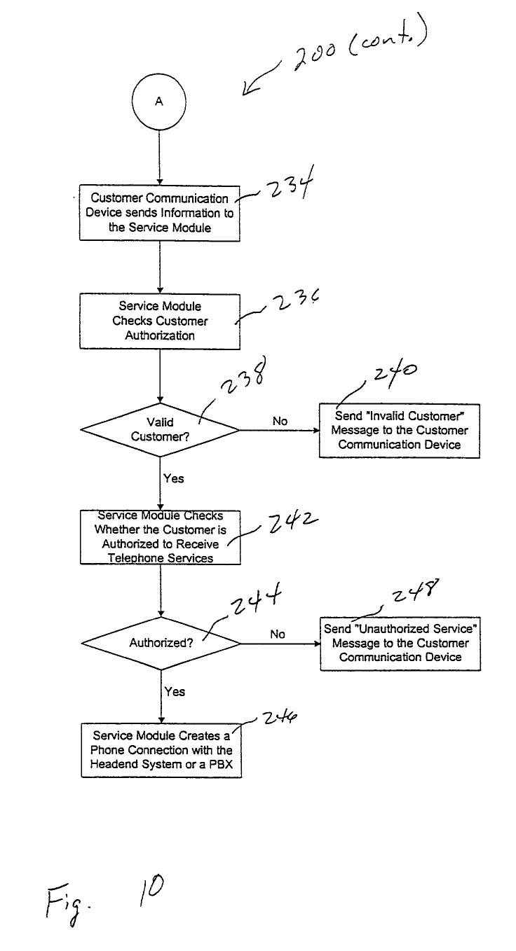

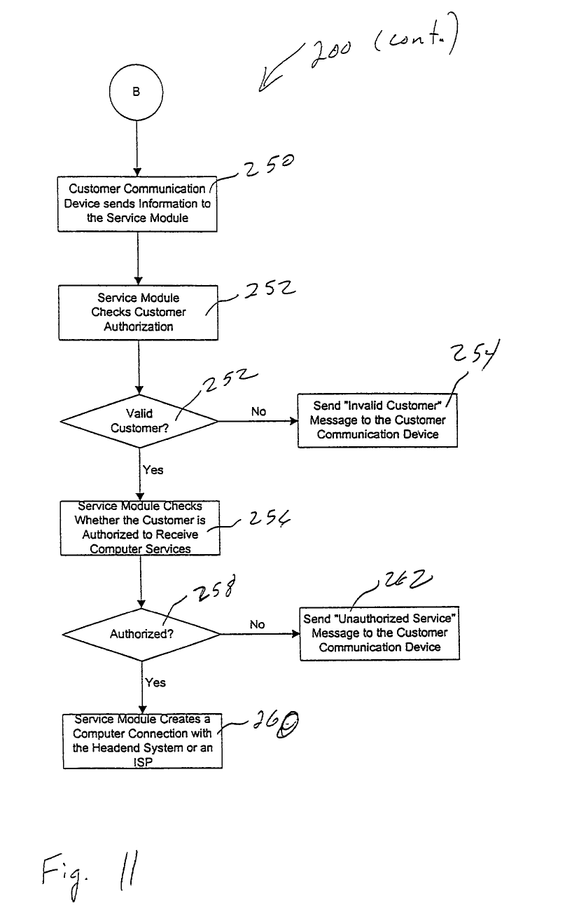

As described above, the present invention provides for a simple, efficient method for a user or subscriber to select a desired service, and for a system to determine if customer or user is valid for that service, and, if so, supply the selected service. Referring now to FIGS. 9, 10 and 11, a flow chart 200 of a method for providing telecommunication services to customers or users is illustrated. In accordance with a preferred method, the customer or user preferably chooses a telecommunication service, such as video, telephone, or computer services. The flow process for telephone services is shown in FIG. 10, while the flow process for computer services is shown in FIG. 11.

Referring now to FIG. 9, the method for providing video services will be discussed. In particular, when a customer selects a video channel for viewing (step 202), the customer communication device or set-top box determines that a video service was requested (step 204) and preferably communicates the selected channel and other user information to the service module (step 206). The service module receives the request and the service module's processor then checks the customer authorization (step 208) and determines whether or not the customer is a valid user (step 210). If not, the service module sends an invalid customer message to the customer communication device and refuses service (step 212). If the customer has a valid account, the cable or paid television channel is selected and processed accordingly (step 214). If a cable channel is selected, the service module checks to determine whether or not the customer is authorized to receive the selected channel (step 216 and 218). If not, an invalid channel message is sent to the customer (step 220). If the customer is authorized to receive the selected cable channel, the signal is decoded and converted to the proper frequency (step 222). Once converted, the signal is sent to the requesting user (step 224).

If a pay-per-view selection is selected by the customer, the service module checks the customer's credit (steps 226 and 228) and, if valid, charges the customer's account or bills the customer (step 230). The service module then decodes the selected channel (step 222), and sends it at the appropriate frequency to the customer's communication device (step 224). If credit is refused, the customer is so advised (step 232).

Telephone and computer selections are handled similarly, as shown in FIGS. 10 and 11. If the customer selects telephone services (FIG. 10), the customer communication device sends a telephone request and the requested telephone number to the service module (step 234). The service module checks the customer authorization (step 236) and determines whether or not the requester is an authorized customer (step 238). If not, the service module sends an invalid customer message to the requesting customer communication device (step 240). If the customer is a valid customer, the service module creates a phone connection between the customer's phone and the headend system, a PBX or a long distance carrier (step 246). Otherwise, the service module sends an unauthorized service message to the requesting customer communication device (step 248).

Likewise, if the customer selects computer communication (FIG. 11), that information is sent by the customer interface to the service module (step 250), wherein the service module again checks customer service authorization (steps 252-258), and, if authorized, the customer receives the desired computer service and the service module creates a computer connection with the headend system (e.g. using a Cable Model Transmission System) or an Internet service provider (step 260). Otherwise, exception messages are sent to the user (steps 254 and 262).

If there is an incoming telephone call to the customer, the service module preferably verifies that this is a valid customer with telephone services, makes a MUX connection to the customer's set-top interface, sends the call through to the customer, and the customers telephone rings. Telephone services offered by the telephone provider can be passed to the customer in the usual manner for use in the usual way.

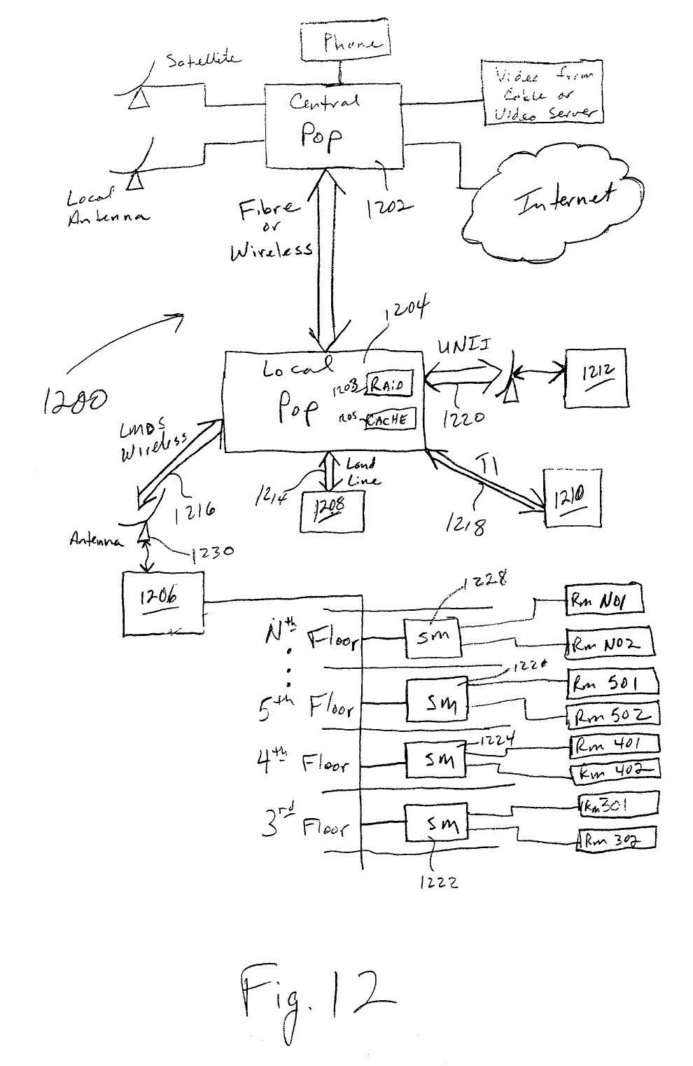

Referring next to FIG. 12, still another embodiment of the present invention which more efficiently distributes voice, video and data to a multiplicity of customers at hotels, residential multiple dwelling units and at small and medium sized offices in multi-story buildings from a centralized server is disclosed. The system utilizes a centralized data server, a distributed service module, and preferably wireless communication to achieve these purposes. While other forms of communication may be utilized, in the wireless communication embodiment, a wide variety of frequency ranges may be used depending upon the regulatory agency frequency allocations. In the US, for example, the system may use the prevailing local multi-point distribution system (LMDS) or the multi-channel, multi-point distribution system frequencies as allocated by the FCC. In addition, the various unlicensed frequencies, such as the 900 MHz, 2.4 GHz, and the unlicensed national information infrastructure (UNII) (5.8 GHz band) frequency ranges can be used.

As shown in FIG. 12, the system 1200 includes a Local Point of Presence 1204 connected to a Centralized Point of Presence 1202. The connection between Local Point of Presence 1204 and Central Point of Presence 1202 can be via a fiber line, via LMDS or other wireless connection, via satellite using one of the C band, Ku band or Ka band video and data distribution services, through a gateway, or with the Local Point of Presence acting as a local terminal or gateway.

In addition, Local Point of Presence 1204 preferably includes one or more redundant arrays of independent discs (“RAID”) or other storage and play back devices. Such devices are adopted to play, on a pay-per-view basis, a large number of movies and programs, much more programming than any hotel can afford to store in their individual systems. Central Point of Presence can also have a number of cache and play devices 1205 that cache material from the web. As those skilled in the art will appreciate, Local Point of Presence 1204 also can act as a fairly sophisticated Video, Web and Data Server (video, Internet and data server) that has the capability to address a large number of users.

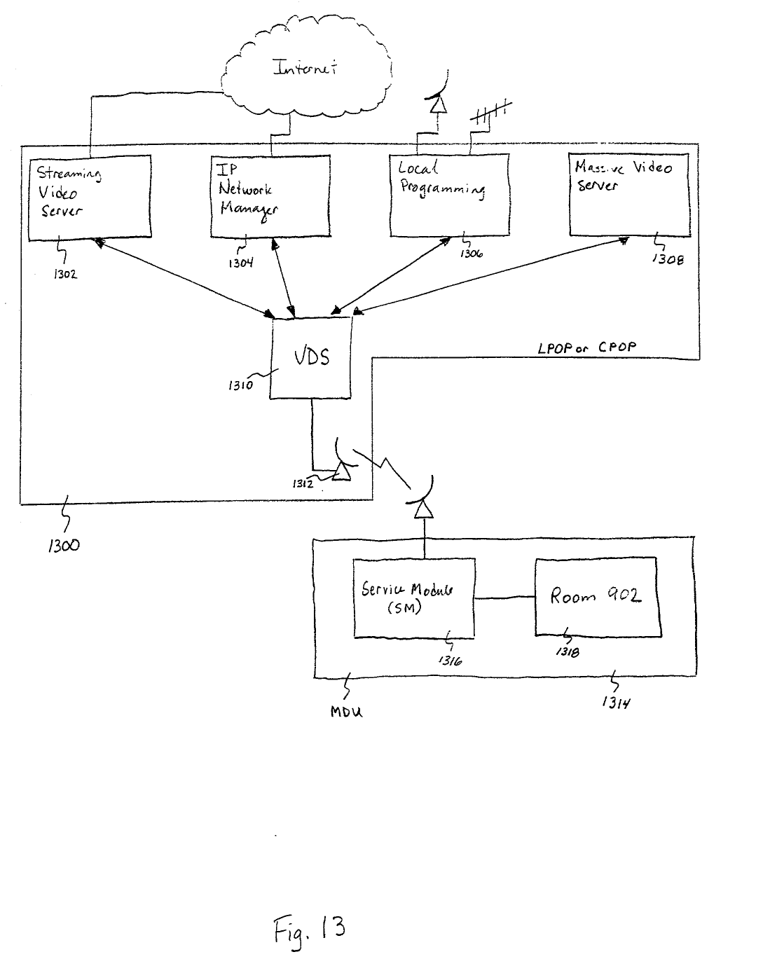

As illustrated in FIG. 12, Local Point of Presence 1204 can receive video, phone and data from Central Point of Presence 1202, or Local Point of Presence 1204 can be configured with the antennas, internet connection, cable connection, etc., so that Central Point of Presence 1202 is not needed. In this aspect of the invention, Local Point of Presence 1204 performs the functions of Central Point of Presence 1202, as well as the other functions of Local Point of Presence 1204. Other details of Local Point of Presence 1204 are described below in connection with FIG. 13.

Local Point of Presence 1204 may connect to a plurality of user sites or centers, such as sites 1206, 1208, 1210, and 1212, as illustrated in FIG. 12. These centers can communicate with Local Point of Presence 1204 via any suitable communication connection such as a land line 1214, an LMDS wireless line 1216, a T1 line 1218, or a 5.8 GHz Unlicensed National Information Infrastructure (UNII) wireless connection 1220. In addition, other suitable communication connections may be used.

The user sites or centers can be any type of use site, such as a business, a hotel, an apartment or other Multiple Dwelling Unit, or the like. In the example shown in FIG. 12, user site 1206, is a Multiple Dwelling Unit, such as a high-rise apartment of hotel. At the Multiple Dwelling Unit there typically is a plurality of residents living on different floors of the Multiple Dwelling Unit (or different buildings of a garden apartment complex). Other user sites could be, for example, a large luxury hotel with hundreds of rooms in a multi story building, a small hotel with very few rooms or even a so-called high-end boutique hotel, or a multi story office building with small and medium offices and retail establishments.

At different floors of each of these buildings are located server modules (SMs), for example, service modules 1222, 1224, 1226, and/or 1228, as shown in user site 1206. The Service Modules communicate with Local Point of Presence 1204 via communication connections, for example, connections 1214-1220. For user site 1206, communication connection 1216 is a LMDS communication connection utilizing a K-band LMDS transceiver unit 1230 including an antenna that is mounted on the roof of the building. User site may also include a local headend system constructed in accordance with headend system 11 of FIG. 1. As one skilled in the art will appreciate, Local Point of Presence 1204 should also include a transceiver and antenna unit.

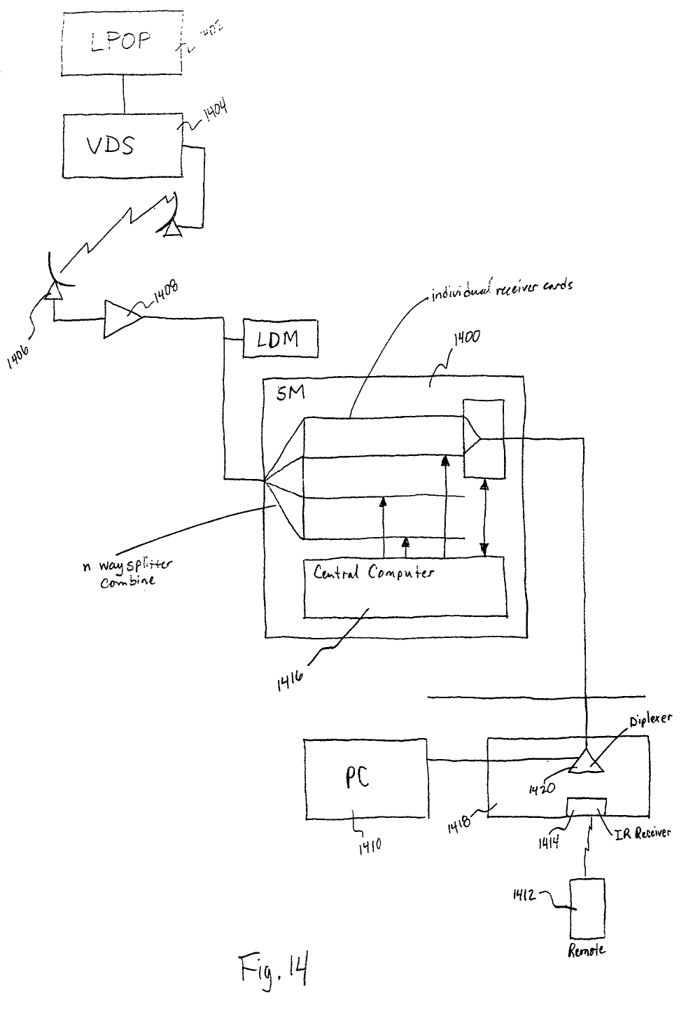

As illustrated in FIG. 12, the Service Modules are connected to rooms, apartments, business offices, etc. For example rooms 301 and 302 are served by service module 1222 on the 3rd floor, and so on. Its is preferred that each Service Module is connected to 20-40 rooms. The Service Modules, which are described in greater detail in connection with FIG. 14 below, perform a number of local functions for the customers in the various rooms. The Service Modules perform in a similar manner as the service modules discussed.

When a customer in a room requests a service, the service module receives this information via a data stream either at baseband or modulated to some RF frequency. The Service Module determines whether this service may be provided to the customer, calculates applicable charges, and determines how the service will be provided, i.e., either from the hotel or building headend itself or from the Local Point of Presence 1204 It does this based on data resident within itself to the extent possible, and by communicating with Local Point of Presence 1204 as necessary.

Present hotel voice, video and data distribution systems have a variety of infrastructure and utilization requirements. In many instances, hotels provide a limited number of local and/or cable television channels to hotel residents, along with pay-per-view movies. The local and/or cable television channels can be provided by connecting to a local cable company, using an antenna, or using a Direct Broadcast Service, for example, via satellite. The pay-per-view movies typically are stored in a centralized system resident at the hotel and then are provided to the rooms when ordered. Some hotels also provide other services, such as video games, hotel information and billing services, and in some cases, internet connectivity, for example, via hotel network to which a laptop personal computer can be connected, via a Webtelevision type connection to the television, or via both.

The resources needed to provide these services to hotels are substantial. A means for high speed connectivity, such as a T1 line is needed to bring in Internet data connectivity. A high memory RAID type video server or a bank of DVD disks or VHS tapes connected to a switch is needed to make pay-per-view movies and programming available. A similarly complex system of game players is needed to make games available in each room. A number of computers are needed in each hotel to manage the interactive sessions with guests as they choose the programming and data services they would like. A transaction monitoring and billing system is required to assure that all services delivered are paid for and properly billed. And a mini headend is needed in each hotel to properly distribute these services to the rooms.

The economics of a system that handles all of these services is such that hotels with fewer than 75 rooms cannot afford such systems. In addition, the utilization of these systems is small, and concentrated in a period of three to five hours. Typical data connectivity utilization is between three and five percent; i.e., only on about 3-5% of the hotel room days see a data connection. pay-per-view purchases occur less than 10% of the time. And, most of the usage is concentrated between the hours of about 5 pm and 10 pm when guests in their rooms are not sleeping. Such utilization drives up the cost of the system on a per room basis, and makes it difficult for hotels to provide a truly wide variety of services to their subscribers. For example, while a wide variety of services, such as high definition television, a broader video selection, tiered programming, value added data services, and high bandwidth connectivity are all technologically possible, they are not typically deployed because of their costs.

The situation is similar in Multiple Dwelling Units especially apartment buildings. In most of these buildings, the occupant turnover rate is 33% annually, and 33% of these renters take the set-top box with them when they vacate the apartment, resulting in lost assets. Data services, while possible to provide, do not have very high connectivity rates. Smaller and older Multiple Dwelling Units are generally more neglected than the newer and bigger ones by operators because of the cost of providing completely new wiring and replacing the existing RG-59 coaxial cable. In Multiple Dwelling Units, as in a majority of residences, the utilization of these services, by and large is concentrated around the evening hours.

This embodiment discloses with reference to FIG. 12 solves these problem areas by creating a system for distributing multimedia signals to hotels and Multiple Dwelling Units during their heavy traffic periods and to businesses during the daytime hours in a much more economical and yet much more flexible fashion.

The system may be used during the entire business day by businesses, and during the evening hours by hotels and Multiple Dwelling Units thereby reducing a cost. It is also sizeagnostic, having the ability to serve hotels, Multiple Dwelling Units, and businesses and is more bandwidth efficient than other systems size only requested data and video programming is sent.

Moreover, the system is fully scalable as the Local Point of Presence is centrally located, it can be outfitted to address increasing traffic without affecting existing services, or even converted to a central POP that serves one or more additional Local Point of Presence. The Local Point of Presence can provide specialized services to specialized customers seamlessly and can communicate with the outside world using Fiber, Wireless, Ka Band Satellite, or a combination of these. Finally, by using distributed architecture service modules, costs within the building, both for service provision, change, and infrastructure are minimized. In particular, Multiple Dwelling Units and Hotels can now be more efficiently served, and the service can be made much more flexible.

Referring next to FIG. 13, an exemplary Point of Presence 1300 is shown. The Local Point of Presence 1300 includes a Video, Internet and data server 1310, which is preferably constructed as a headend system in accordance with system 11 of FIG. 1. The Video, Internet and data server 1310 functions in many respects to video and data servers currently available in the market today, with certain notable exceptions. For one, video, Internet and data server 1310 is designed as a system that sends only the programming requested or the programming that is directed by, for example the Hotel Management, to any party. Thus, in the illustrated embodiment, 1302 is a video stream server, 1304 is an IP Network Manager that controls access to the internet with different levels of access provisioning, 1306 is programming from a local source and 1308 is a massive video server. Additional sources may also be involved.

Since the system disclosed in FIG. 12 provides for a flexible architecture, the Local Point of Presence may be situated as any convenient location, not being restricted to being in close proximity with the Service Modules 1222-1228. Moreover, while FIG. 12 shows a Central Point of Presence 1202, the system does not require a Central Point of Presence for operation, and can readily be modified to include only one ore more Local Points of Presence. Indeed, with such an arrangement, any local headend (e.g., at site 1206) and Local Point of Presence can be distributed in accordance with the location(s) of the buildings and the types of services to be provided to the building resident, i.e., Internet and video.

In a particular example, when a customer requests a video, say a pay-per-view movie, from room 902, which is illustrated as reference numeral 1318, this request is authenticated by Service Module 1316 in communication with the Local Point of Presence or Central Point of Presence, shown in FIG. 13 as reference numeral 1300. If it is acceptable to provide the movie, then the video server 1038 is commanded to provide the movie. The movie preferably is delivered from video server 1308 in a MPEG-2 or other acceptable coded bit stream. From the segment in which the above-mentioned room 902 exists, there may be many such movie requests, both pay and free. All these create video streams from video server 1308 or other such devices.

Video, Internet and data server 1310 combines several outputs, compresses them and modulates them on to cable channel frequencies, encrypts the compressed output if desired, and sends the channel assignments as well as the virtual channel assignments to each of the various Service Module devices so that each Service Module device decodes the appropriate bit stream and sends it on to the particular subscriber. As such, server 1310 includes a channel combiner and compressor dedicated to each segment. As shown in FIG. 12, a segment may consist of many office buildings, hotels, and Multiple Dwelling Units. For example, a segment may be within an arc of 60 to 90 degrees and within a distance of 5 miles from the Local Point of Presence. In a metropolitan or dense suburban are, this could cover a very large number of possible subscribers.

If the same programming, for example a pay television program or free to air program, is being requested by a number of people in different segments of Local Point of Presence 1300, only one bitstream needs to be generated. Video, Internet and data server 1310 recognizes this and distributes it appropriately. In this fashion, server 1310 assures that Local Point of Presence 1300 sends only those channels that are being requested, rather than every free to air channel, every pay per view channel, and every near video on demand channel that most systems carry, most of which are never even seen in many segments.

When a customer, for example in room 904 (not shown), requests a connection to the Internet, Service Module 1316 verifies that the customer is a paying client, or sets up an account so that the customer can be served. The request then goes to IP Network Manager 1304, which carries out IP spoofing, appropriate Portal serving, and provides the customer a path to the Internet. This video stream is in the upstream modulated on to a cable channel, encoded appropriately, combined with other similar data channels, and sent to Service Module 1316. Based upon the address given and encoding, Service Module 1316 selects the appropriate data stream and sends it on to the customer using a LAN protocol. The customer requires only a LAN card on the computer to make the connection, which may be Mbps in magnitude. Furthermore, the customer does not get any of the data intended for another customer, since Service Module 1316 is neither in his dwelling nor under his control, other than to make legitimate requests. This enhances the system data security.

If the customer makes a video stream request, IP manager 1304 commands video stream server 1302 to provide the stream, video, Internet and data server 1310 modulates it on an appropriate RF channel and sends it to the particular segment antenna or feed cable. Again, a number of like requests are modulated and encoded.

It should be noted that all the paths between Service Module 1316 and video, Internet and data server 1310 are two way channels. The return channels, very much like the cable return path or upstream channels can be lower in bandwidth than the downstream channels. They handle customer requests, LSM-video, Internet and data server communications, and return path or upstream data.

With the arrangement described with reference to FIG. 13, each signal path only contains requested programming, encoded and compressed. A rogue receiver not only has to decode the programming, whose key, since it is not in customer control, can be switched at will, but even after the rogue decodes it, they can only see what someone else ordered at that time there is no wasted bandwidth and is more secure for data transmission than Data-Over-Cable Service Interface Specification based cable modems.

The system can be used to serve multiple hotels, regardless of size. Further, any hotel can receive any service, at different price and service levels. For example, high definition television can be provided to select rooms at select hotels, and at the same time NVOD can be provided to some rooms, SVOD to others, pay-per-view to others, and so on, or any combination of all the above. It should also be noted that the bandwidth available is repeatable in each segment. This means that with n segments virtually n times the bandwidth of one system is available.

Referring next to FIG. 14, a preferred Service Module useful in the arrangement disclosed with respect to FIGS. 12 and 13 is now described. The Service Module two way communications between the video, Internet and data server and the customer. As illustrated in FIG. 14, Service Module 1400 may have a number of cards in a box, each of which is the appropriate decoder for a television or data terminal or laptop. Service Module 1400 may also have a central processor and power supply for each of these cards.

In FIG. 14, the incoming signal comes from the video, Internet and data server at the Local Point of Presence via antenna 1406 and amplifiers 1408 to Service Module 1400. Within Service Module 1400, the signal is split into a number of receivers, one for each room. For example, if room 901 is equipped with a high definition television, its receiver card is an high definition television receiver card. Further, if room 902 is equipped with two television sets, its receiver is capable of receiving two different channels, modulating them on to preset television channels, and combining the two, and sending them to the room. If the room also has a PS connection port, the Service Module card for the room has the appropriate provisioning to provide the 10 bit T Ethernet connection to the room.

If all the rooms are loop through, the individual channels are modulated differently and sent down the coaxial cable. If they are home run, then they are individually modulated and sent to each room.

Communications with the room for video services may occur via infrared or other remote controls. IR remote control 1412, when pressed, communicates with an IR receiver 1414 that may be inconspicuously wall mounted. Receiver 1414 converts the signal to digital, and sends it to Service Module 1400. Computer 1416 verifies that the request is authorized, and commands receiver to tune and decode the appropriate channels as video, Internet and data server 1404 has indicated. Within Service Module 1400, the decoded signal is appropriately modulated in a modulator, combined in a combiner, and sent to the room.

If a PC or data request is sent, IR flows through receiver 1418 which has a diplexer 1420, and sends the request to Service Module 1400, where computer 1416 verifies it and commands the server connection made. Further, if telephone service is added to the system, it may be handled in a manner similar to that described in connection with FIG. 2.

The Service Module 1400 is advantageous as in that it allows services to any room or apartment or business to be switched without the need to enter the premises, and removes the need for any cable set top of any sort in the apartment. Moreover, use of Service Module 1402 does not necessitate the need to rewire the building, while the configuration significantly enhances security.

In conclusion, the present invention provides a novel telecommunication system for providing a plurality of telecommunication services to plurality of customers in a secure, inexpensive manner. While a detailed description of presently preferred embodiments of the invention have been given above, various alternatives, modifications, and equivalents will be apparent to those skilled in the art. For example, while difference compounds or circuits of the services module of the present invention are described herein as performing certain specific functions, one skilled in the art will appreciate that other components or circuits in the service module may perform some or all of the service module functions without varying from the spirit of the invention. Therefore, the above description should not be taken as limiting the scope of the invention which is defined by the appended claims.

We claim:

1. A system for securely communicating multimedia information from one or more multimedia content sources to a plurality of end users, comprising:
(a) a headend system receiving one or more multimedia information signals from said one or more content sources and user authorization information corresponding to one or more of said plurality of end users, combining said one or more multimedia information signals into a headend composite signal, and generating a secure headend output signal using said user authorization information and said headend composite signal;
(b) a signal distribution system, communicatively coupled to said headend system and receiving said secure headend output signal therefrom, said signal distribution system including:
(i) one or more signal decoders, each receiving at least a portion of said secure headend output signal, for converting said signal portion into one or more modulated channel signals if authorized by said user authorization information; and
(ii) one or more output interfaces, each coupled to one of said signal decoders and receiving one or more modulated channel signals therefrom, for combining said one or more modulated channel signals into a composite user signal; and
(c) one or more customer interface devices, each communicatively coupled to one of said output interfaces and receiving a corresponding composite user signal therefrom, and each for dividing, if necessary, and demodulating said composite user signal to one or more end user signals.

2. The system of claim 1, wherein said multimedia information signals are selected from the group consisting of video signals, terrestrial television signals, satellite signals, cable television signals, telephony signals, Internet signals, and data signals.

3. The system of claim 1, wherein said headend system further comprises one or more multimedia signal reception connections selected from the group consisting of a POTS phone line, a DSL line, coaxial cable, fiber optic cable, a satellite dish antenna, and an off the air antenna, for receiving said one or more multimedia information signals from said one or more content sources.

4. The system of claim 1, wherein said headend system further comprises:
(a) one or more receiver decoders, each receiving one or more multimedia information signals from one of said one or more content sources and converting said multimedia information signals into one or more baseband frequency signals,
(b) a video processor, coupled to each of said receiver decoders, receiving said baseband frequency signals, and modulating said baseband frequency signals to one or more channels; and
(c) a combiner circuit, coupled to said video processor, receiving said one or more modulated channel signals and combining said channel signals into said headend composite signal.

5. The system of claim 4, wherein said headend system further comprises an access control system, coupled to said combiner circuit and receiving said headend composite signal therefrom, for determining whether one or more users are authorized to receive any of said channels included in said headend composite signal.

6. The system of claim 5, wherein said headend system further comprises a data path modulator, coupled to said access control system and receiving said authorized headend composite signal therefrom, for transmitting said headend authorized composite signal and authorization information as said headed output signal.

7. The system of claim 1, wherein said multimedia information includes signals selected from the group consisting of telephony signals, Internet signals, data signals, and terrestrial television signals, and wherein said combiner circuit of said headend system is adapted for combining said channel signals and said telephony signals, Internet signals, data signals, and/or terrestrial television signals into said headend composite signal, said distribution system further comprising:
(a) a service interface, coupled to each of said signal decoders, for receiving said secure headend output signal and dividing said secure headend output signal into a video signal and one or more telephony, Internet, data, and/or terrestrial television signals, and
(b) a communication service module, coupled to said service interface, for receiving and distributing said telephony, Internet, data, and/or terrestrial television signals.

8. The system of claim 7, wherein said signal distribution system further comprises a processor, coupled to said service interface, said signal decoders and said output interfaces, and receiving said authorization information from said headend system though said service interface, for controlling a selection of channels provided to said plurality of customer interface devices in accordance to said authorization information.

9. The system of claim 8, wherein said customer interface devices further comprises at lest one customer input device, operatively coupled to said signal distribution system processor, for receiving customer requests and providing such requests to said signal distribution system processor.

10. The system of claim 1, wherein said customer interface devices further comprises:
(a) an interface device for receiving a composite user signal from one of said output interfaces and dividing said signal into video and telephony, Internet, data, and/or terrestrial television signals;
(b) a communications modem, coupled to said interface device and receiving said telephony, Internet, data, and/or terrestrial television signals, for demodulating said telephony, Internet, data, and/or terrestrial television signals into one or more of said end user signals; and
(c) a processor, coupled to said interface device and to said communications modem, for controlling said dividing and demodulating of said composite user signal to said one or more end user signals.

11. A system for securely communicating multimedia information from one or more multimedia content sources to a plurality of end users who share a common loop through communication channel, comprising:
(a) a multimedia reception system for receiving one or more multimedia information signals from said one or more content sources and user authorization information corresponding to one or more of said plurality of end users, combining said one or more multimedia information signals into a headend composite signal, and generating a secure output signal using said user authorization information and said headend composite signal;
(b) a signal distribution system, communicatively coupled to multimedia reception system and receiving said secure output signal therefrom, said signal distribution system including:
(i) a signal splitter for dividing said secure output signal into a plurality of service signals,
(ii) a plurality of signal decoders, each coupled to said signal splitter and receiving at least a portion of one of said plurality of service signals, for converting said signal portion into one or more modulated channel signals corresponding to one predetermined user if authorized in conformance with said user authorization information; and
(iii) a combining circuit, coupled to each of said plurality of signal decoders and receiving said modulated channel signals therefrom, for combining said modulated channel signals into a composite multiple user signal;
(c) a loop through communication channel, coupled to said combiner circuit of said signal distribution system and receiving said composite multiple user signal therefrom; and
(d) a plurality of customer devices, each coupled to said loop through communication channel and receiving said composite multiple user signal therefrom, and each including a filter permitting transmission of only multimedia information corresponding to a predetermined customer therethrough.

12. The system of claim 11, wherein said headend system further comprises:
(a) one or more receiver decoders, each receiving one or more multimedia information signals from one of said one or more content sources, for converting said multimedia information signals into one or more baseband frequency signals,
(b) a video processor, coupled to one or more of said receiver decoders, receiving said baseband frequency signals and modulating said baseband frequency signals to one or more channels; and
(c) a combiner circuit, coupled to said video processor, receiving said one or more modulated channel signals and combining said channel signals into said headend composite signal.

13. The system of claim 12, wherein said headend system further comprises an access control system, coupled to said combiner circuit and receiving said headend composite signal therefrom, for determining whether one or more users are authorized to receive any of said channels included in said headend composite signal.

14. The system of claim 13, wherein said headend system further comprises a data path modulator, coupled to said access control system and receiving said authorized headend composite signal therefrom, for transmitting said headend authorized composite signal and authorization information as said headed output signal.

15. The system of claim 11, wherein said plurality of signal decoding comprises M signal decoders, said plurality of customer interface devices comprises N customer interface devices, and wherein M<N.

16. The system of claim 11, wherein said signal distribution system further comprises a processor, coupled to said splitter, said signal decoders and said output interfaces, and receiving said authorization information from said headend system through said splitter, for controlling a selection of channels provided to said plurality of customer interface devices in accordance with said authorization information.

17. The system of claim 11, wherein said plurality of customer devices comprise:
(a) a plurality of couplers, each one corresponding to a different one of said plurality of customer devices and including one of said filters; and
(b) a plurality of customer interface devices, each one coupled to a different one of said plurality of couplers and receiving a filtered signal therefrom.

18. The system of claim 17, wherein said customer interface devices further comprises at lest one customer input device, operatively coupled to said signal distribution system processor, for receiving customer requests and providing such requests to said processor.

19. The system of claim 17, wherein said multimedia information includes signals selected from the group consisting of telephony signals, Internet signals, data signals, and terrestrial television signals, said combiner circuit of said headend system combining said channel signals and said telephony signals, Internet signals, data signals, and/or terrestrial television signals into said composite signal, and wherein said distribution system further comprises:
(a) a service interface, coupled to said splitter and to each of said plurality of signal decoders, for receiving said split signal from said splitter and dividing said split headend output signal into video and telephony, Internet, data, and/or terrestrial television signals, and
(b) a communication service module, coupled to said splitter, for receiving and distributing said telephony, Internet, data, and/or terrestrial television signals to said plurality of couplers, and
wherein each of said filters comprises a first filter for filtering a video portion of said composite multiple view signal and a second filter for filtering said telephony, Internet, and/or data signals.

20. The system of claim 19, wherein said first filter comprises a tuner operable only by said signal distribution system.

21. A system for securely communicating multimedia information from one or more multimedia content sources to a plurality of end users, comprising:
(a) one or more a point of presence systems for receiving one or more multimedia information signals from said one or more content sources and user authorization information corresponding to one or more of said plurality of end users, combining said one or more multimedia information signals into a composite signal, and generating a secure output signal using said user authorization information and said composite signal;
(b) signal distribution means, communicatively coupled to one of said point of presence systems and receiving a secure output signal therefrom, including:
(i) one or more signal decoder means, each receiving at least a portion of said secure output signal, for converting said signal portion into one or more modulated channel signals if authorized by said user authorization information; and
(ii) one or more output interface means, each coupled to one of said signal decoder means and receiving one or more modulated channel signals therefrom, for combining said one or more modulated channel signals into a composite user signal; and
(c) one or more customer interface means, each communicatively coupled to one of said output interface means and receiving a corresponding composite user signal therefrom, and each including means for dividing, if necessary, and demodulating said composite user signal to one or more end user signals.

22. The system of claim 21, wherein said multimedia information signals are selected from the group consisting of video signals, terrestrial television signals, satellite signals, cable television signals, telephony signals, Internet signals, and data signals.

23. The system of claim 21, wherein said point of presence system further comprises means for receiving one or more types of multimedia signals selected from the group consisting of a POTS phone line, a DSL line, coaxial cable, fiber optic cable, a satellite dish antenna, and an off the air antenna.

24. The system of claim 21, wherein said point of presence system further comprises:
(a) one or more receiver decoder means, each receiving one or more multimedia information signals from one of said one or more content sources, for converting said multimedia information signals into one or more baseband frequency signals,
(b) video processor means, coupled to said receiver decoder means, for receiving said baseband frequency signals and modulating said baseband frequency signals to one or more channels; and
(c) combiner means, coupled to said video processor means, for receiving said one or more modulated channel signals, and combining said channel signals into said composite signal.

25. The system of claim 24, wherein said point of presence system further comprises access control means, coupled to said combiner means and receiving said composite signal therefrom, for determining whether one or more users are authorized to receive any of said channels included in said composite signal.

26. The system of claim 25, wherein said point of presence system further comprises data path modulation means, coupled to said access control means and receiving said authorized composite signal therefrom, for transmitting said authorized composite signal and authorization information as said output signal.

27. The system of claim 21, wherein said multimedia information includes signals selected from the group consisting of telephony signals, Internet signals, data signals, and terrestrial television signals, and wherein said coupled point of presence system is adapted for combining said channel signals and said telephony signals, Internet signals, data signals, and/or terrestrial television signals into said composite signal, said signal distribution means further comprising:
(a) interface means, coupled to each of said signal decoder means, for receiving said secure output signal and dividing said output signal into video and telephony, Internet, data, and/or terrestrial television signals, and
(b) communication service means, coupled to said interface means, for receiving and distributing said telephony, Internet, data, and/or terrestrial television signals.

28. The system of claim 27, wherein said signal distribution means further comprises processing means, coupled to said interface means, said signal decoder means and said output interface means, and receiving said authorization information from said point of presence system through said service interface, for controlling a selection of channels provided to said plurality of customer interface means.

29. The system of claim 21, wherein said one or more point of presence systems comprises two or more point of presence systems operatively coupled by one or more wireless communication channels.

30. The system of claim 21, wherein at least one of said one or more point of presence systems is coupled with said signal distribution means by one or more wireless communication channels.

31. A method for securely communicating multimedia information from one or more multimedia content sources to a plurality of end users, comprising the steps of:
(a) receiving one or more multimedia information signals from said one or more content sources and user authorization information corresponding to one or more of said plurality of end users;
(b) combining said one or more multimedia information signals into a headend composite signal;
(c) generating a secure headend output signal using said user authorization information and said headend composite signal;
(d) transmitting said secure headend output signal to one or more signal distribution locations;
(e) converting at least a portion of said secure headend output at said one ore more signal distribution locations into one or more modulated channel signals if authorized by said user authorization information;
(f) combining said one or more modulated channel signals into a composite user signal;
(g) transmitting said composite user signal to one or more customer locations;
(h) receiving at least a portion of said composite user signal at said one or more customer locations; and
(i) dividing, if necessary, and demodulating said received signal to one or more end user signals.

32. The method of claim 31, wherein said multimedia information signals are selected from the group consisting of video signals, terrestrial television signals, satellite signals, cable television signals, telephony signals, Internet signals, and data signals.

33. The method of claim 31, wherein said step (b) further comprises the steps of:
(a) converting said multimedia information signals into one or more baseband frequency signals,
(b) modulating said baseband frequency signals to one or more channels; and
(c) combining said channel signals into said headend composite signal; and
wherein said step (c) further comprises the step of determining whether one or more users are authorized to receive any of said channels included in said headend composite signal.

34. The method of claim 33, wherein step (g) further comprises the step controlling a selection of channels transmitted in accordance to said authorization information.

35. The method of claim 31, further comprising the step of transmitting customer request information from at least one customer location to at least one signal distribution location.
